(19) United States
(12) Patent Application Publication
(10) Pub. No.: US 2014/0236658 A1
(43) Pub. Date: Aug. 21, 2014

(54) Semi-automated relationship aware scheduling

(71) Applicant: 3C CAPITAL, LLC, Livingston, NJ (US)

(72) Inventors: Marc Friedfertig, Livingston, NJ (US); Alex Kane, Brooklyn, NY (US)

(73) Assignee: 3C CAPITAL, LLC, Livingston, NJ (US)

(21) Appl. No.: 13/999,326

(22) Filed: Feb. 11, 2014

Related U.S. Application Data
(63) Continuation-in-part of application No. 13/507,403, filed on Jun. 26, 2012, now Pat. No. 8,738,413.
Application No. 13/507,403 is a continuation of application No. 12/589,102, filed on Oct. 16, 2009, now Pat. No. 8,239,235.

(51) Int. Cl. G06Q 10/10

(52) U.S. Cl. CPC G06Q 10/1095
USPC 705/7.19

(57) ABSTRACT

Schedules which include reciprocal events, such as schedules for youth hockey leagues, can be created using a system in which users can invite one another to schedule games based on information selected through an interface and reciprocal dates which are automatically identified by a suitably programmed computer. Information related to games and schedules can be stored in a database which can be accessed and modified by different users depending on their roles and the permissions associated with those roles.

### CROSS REFERENCE TO RELATED APPLICATIONS

This is a continuation in part of non-provisional patent application Ser. No. 13/507,403, filed on Jun. 26, 2012, which is itself a continuation of non-provisional patent application Ser. No. 12/589,102, filed on Oct. 16, 2009 having the same title and inventors as the present application.

### INCORPORATION BY REFERENCE

This application incorporates by reference in its entirety the information from the computer program listing appendix submitted herewith, comprising the files listed in the table below:

| Name | Size | Created |
|---|---|---|
| SourceFile1.txt | 438,577 bytes | Oct. 9, 2009 |
| SourceFile2.txt | 450,145 bytes | Oct. 9, 2009 |
| SourceFile3.txt | 41,835 bytes | Oct. 9, 2009 |
| SourceFile4.txt | 34,661 bytes | Oct. 9, 2009 |
| available_home_ice_date.rb | 3,421 bytes | Oct. 15, 2009 |
| available_travel_date.rb | 3,497 bytes | Oct. 15, 2009 |
| calendar_event.rb | 8,845 bytes | Oct. 15, 2009 |
| game.rb | 3,979 bytes | Oct. 15, 2009 |
| proposal.rb | 7,514 bytes | Oct. 15, 2009 |

on the compact disc submitted herewith, and the computer program which is represented by their combination. Two identical discs, each containing the files listed above are submitted herewith.

### BACKGROUND

Without automation, scheduling of reciprocal events can be a difficult and time consuming endeavor. For example, in the case of youth hockey, because of the expense associated with ice time and officials, when a game is scheduled at one team's home location, it is often desirable to simultaneously schedule “reciprocal dates” or “reciprocal games” where the team which hosted the first game can be hosted in a second. Currently, the standard approach in youth hockey is to create schedules manually, with a master scheduler spending days and in many cases weeks trying to match the teams in the league with one another while balancing home and away games. There are many problems with this approach, especially as applied in leagues with multiple people responsible for scheduling (e.g., one master scheduler for each organization). First, because master schedulers are generally not professional hockey schedulers, it can be difficult for individuals to coordinate with one another, and to find time to devote to scheduling. Second, in cases where there are multiple master schedulers who meet to create a schedule, there are costs associated with simply setting up a meeting (e.g., money required to rent space, time required for schedulers to travel to the meeting, food and electricity costs associated with running the meeting, etc). Third, actually creating the schedule can be difficult because successful rinks have limited flexibility as downtime is minimize and many leagues are limited to playing games only on specific days (e.g., weekends).

In addition to the difficulties associated with reciprocation, a further layer of complexity exists when there are practical linkages between nominally independent events. For example in the case of youth hockey, while different teams could theoretically schedule games at any time they are free and there is available ice, in practice there are some teams which should, if at all possible, be scheduled to play their games on the same day at a single location. An example of such teams is teams within a single association which might share resources, such as a coach, which could not reasonably be expected to be available at multiple widely separated locations in a single day. As with reciprocation, current manual scheduling techniques provide no effective way of accounting for these types of practical linkages.

Despite these well known and longstanding difficulties with manual scheduling, attempts at automated scheduling tools, such as LeagueUSA, have not met these needs, largely because they lack the flexibility to allow individual schedulers to perform the (often qualitative) balancing between factors such as team rivalries, distances between teams, and coaches and player preferences which would enhance the scheduling process. Furthermore, they do not allow for identifying reciprocal slots or relationships between teams which should be scheduled together due to shared resources or other reasons. Additionally, attempts to make scheduling easier by purchasing excess slots or expanding available resources (e.g., hiring additional coaches) have resulted in significantly increasing the costs associated with running and creating a schedule for a league. As a result, there is a long-felt but unmet need in the field of youth hockey scheduling for an approach which can replace current manual scheduling techniques while still allowing flexibility to consider factors which might be important in a particular instance. Further, other fields which currently use similar methods to those employed in youth hockey scheduling and where a suitable automated technology is not available would also substantially benefit from a flexible automated or semi-automated scheduling technology that allows for identifying reciprocal ice and linkages between teams and allows for one or multiple schedulers to schedule with their own preferences.

### SUMMARY

Disclosed herein are techniques which can be used in a variety of settings, including facilitating scheduling for teams, organizations and leagues through the identification of reciprocal ice or linkages between teams. Various aspects of this disclosure can be implemented in the form of computer readable media which can receive input from users, automatically identify possible opponents for a youth hockey team, as well as other teams which are linked to those possible opponents, and generate invitations which can be used to schedule games between the team, a selected possible opponent, and the other teams to which they are linked.

Of course, the teachings set forth herein are susceptible to being implemented in forms other than computer readable media. For example, based on the teachings of this disclosure, one of ordinary skill in the art could implement a system including a database, a server computer and one or more user computers in which the user computers could be used to schedule games for a youth hockey league relying on processing done by the server and information stored in the database. Various other methods, machines, and articles of manufacture could also be implemented based on this disclosure by those of ordinary skill in the art without undue experimentation, and should not be excluded from protection by claims included in this or any related document.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings and detailed description which follow are intended to be merely illustrative and are not intended to limit the scope of the invention as contemplated by the inventors.

FIG. 1 depicts a process which could be followed to create a schedule for a double round robin youth hockey league.

FIG. 2 depicts an architecture which could be used in implementing some aspects of this disclosure.

FIG. 3 depicts a calendar interface which could be used to facilitate the scheduling of games in a youth hockey league.

FIG. 4 depicts a calendar interface which could be used to facilitate the scheduling of games in a youth hockey league.

FIG. 5 depicts a calendar interface which could be used to facilitate the scheduling of games in a youth hockey league.

FIG. 6 depicts a calendar interface which could be used to facilitate the scheduling of games in a youth hockey league.

FIG. 7 depicts a calendar interface which could be used to facilitate the scheduling of games in a youth hockey league.

FIG. 8 depicts a calendar interface which could be used to facilitate the scheduling of games in a youth hockey league.

FIG. 9 depicts a calendar interface which could be used to facilitate the scheduling of games in a youth hockey league.

FIG. 10 depicts a calendar interface which could be used to facilitate the scheduling of games in a youth hockey league.

FIG. 11 depicts a calendar interface which could be used to facilitate the scheduling of games in a youth hockey league.

FIG. 12 depicts a calendar interface which could be used to facilitate the scheduling of games in a youth hockey league.

FIG. 13 depicts a calendar interface which could be used to facilitate the scheduling of games in a youth hockey league.

FIG. 14 depicts a list interface which could be used to facilitate the scheduling of games in a youth hockey league.

FIG. 15 depicts a list interface which could be used to facilitate the scheduling of games in a youth hockey league.

FIG. 16 depicts a model which could be used to implement certain aspects of this disclosure.

FIG. 17 depicts a model which could be used to implement certain aspects of this disclosure.

FIG. 18 depicts a model which could be used to implement certain aspects of this disclosure.

FIG. 19 depicts a model which could be used to implement certain aspects of this disclosure.

FIG. 20 depicts controllers which could be used to implement certain aspects of this disclosure.

FIG. 21 depicts controllers which could be used to implement certain aspects of this disclosure.

FIG. 22 depicts controllers which could be used to implement certain aspects of this disclosure

FIG. 23 depicts controllers which could be used to implement certain aspects of this disclosure

FIG. 24 depicts an illustrative scheduling process.

FIG. 25 depicts an interface which can be used to add and define links between teams.

FIG. 26 depicts an interface which can be used to select a day to schedule travel games and teams for which the travel games should be scheduled.

FIG. 27 depicts an interface with an invitation creation tool.

FIG. 28 depicts an interface with an alternate invitation creation tool.

FIG. 29 depicts a slot matching tool.

FIG. 30 depicts an interface which can be used to view and respond to an invitation.

### DETAILED DESCRIPTION

The inventors have conceived of novel technology which, for the purpose of illustration, is disclosed herein as applied to the context of scheduling ice slots for a youth hockey league. While the application of the inventors' technology in the context of scheduling ice slots for a youth hockey league satisfies a long-felt but unmet need in that field, it should be understood that the disclosure of the inventors' technology in that context should not be treated as implying limitations on potential fields where aspects of the inventors' technology can be beneficially applied. Accordingly, the disclosure set forth herein should be understood as being illustrative only, and not limiting.

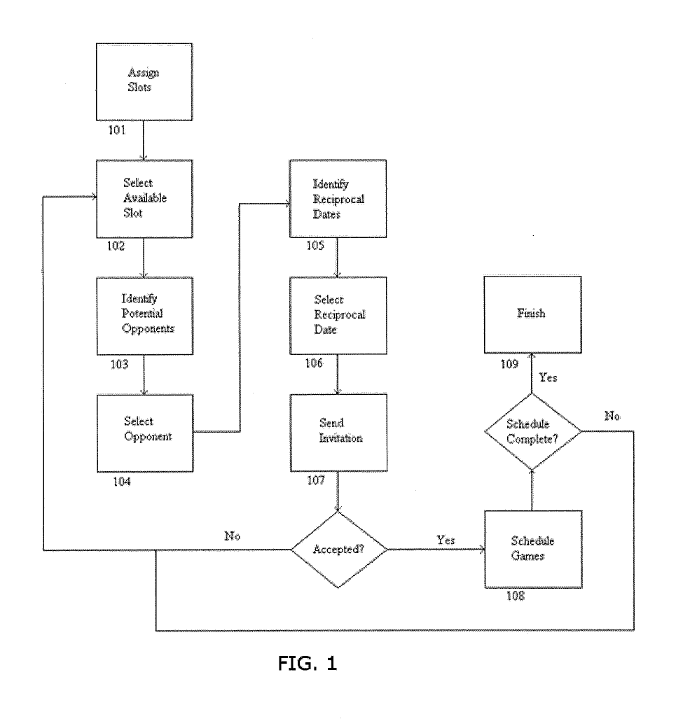

Turning now to the images, FIG. 1 depicts a process which could be followed by a scheduler to create a schedule for a double round robin youth hockey league. In the process of FIG. 1, the creation of the schedule could begin by defining the events [101] for the various teams in the league. This could correspond to a real world activity, such as buying blocks of time at skating rinks which would be used by the organization and then treating those blocks as potential home games (a first type of event) for their respective teams, and treating dates when a team is available but does not have a potential home game as potential away games (a second type of event). As set forth, this could take place on a league-wide basis (i.e., for all teams in a league) or on an organization by organization level (e.g., there could be a plurality of teams at different age and/or skill levels who would have a common home field and access to commonly purchased blocks of time). This step could also take place in phases. For example, a master scheduler could first determine what days teams in a league are potentially available, and schedule each of those days as potential away games. Then, after the days when the teams are potentially available had been scheduled, blocks of ice could be purchased and allocated to those teams, and the potential away games on dates where ice had been purchased could be converted into potential home games corresponding to the purchased blocks. Of course, other variations are also possible, and may be implemented based on regional preferences or conditions. Accordingly, the discussion of assigning events [101] should be understood as being illustrative only, and not limiting.

However it takes place, once the events for the league had been assigned [101], games could be scheduled on a team-by-team basis. To do this, the manager could select a potential event [102] for a team and the other teams in the league which are available for that potential event could be identified [103]. For example, if the potential event is a potential away game event where a team can play an away game between 11:00 am and 5:00 pm, a computer program could be used to identify teams which had potential home game events which started on or after 11:00 am and on or before 5:00 pm. Using some criteria (or randomly) the manager could select one of the potential opponents [104], and then identify reciprocal dates [105] which are available for the opponent to play its second game against the team being scheduled. The manager would then select a reciprocal date [106], and send an invitation [107] for the games to the coaches of the selected teams. If the invitation is rejected, then the process could return to selecting a different potential event [102]. If it is accepted, the games could be scheduled [108] and a check could be performed to see if the schedule for the league was complete. If it was (e.g., if each team had had two games scheduled with every other team) then the scheduling process could finish [109], perhaps by allowing individual coaches to schedule non-league games for potential events which weren't used for games. If the scheduling process was not finished, then the described sequence of events could be repeated starting with the selection of a potential event [102] to schedule an additional game.

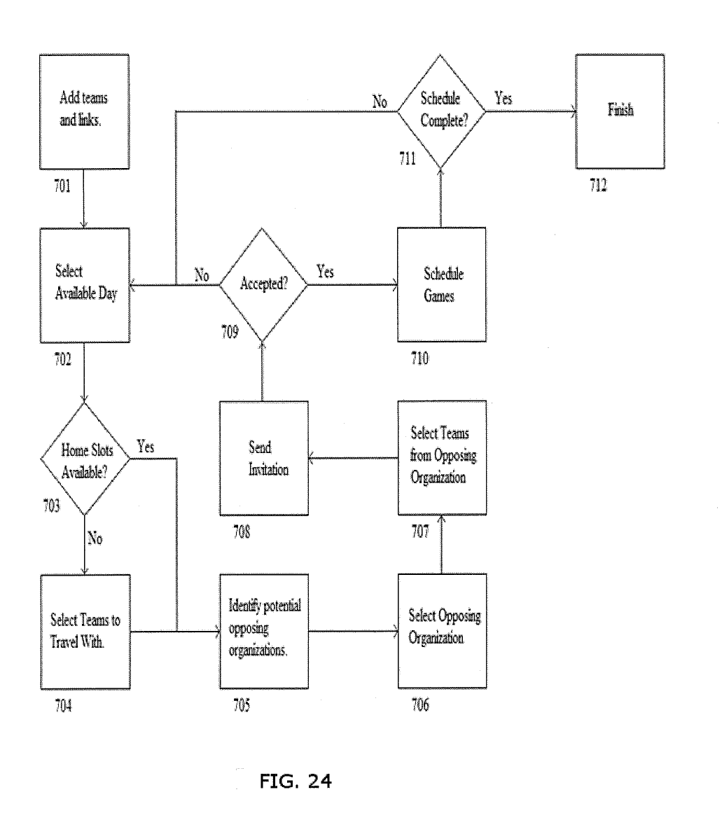

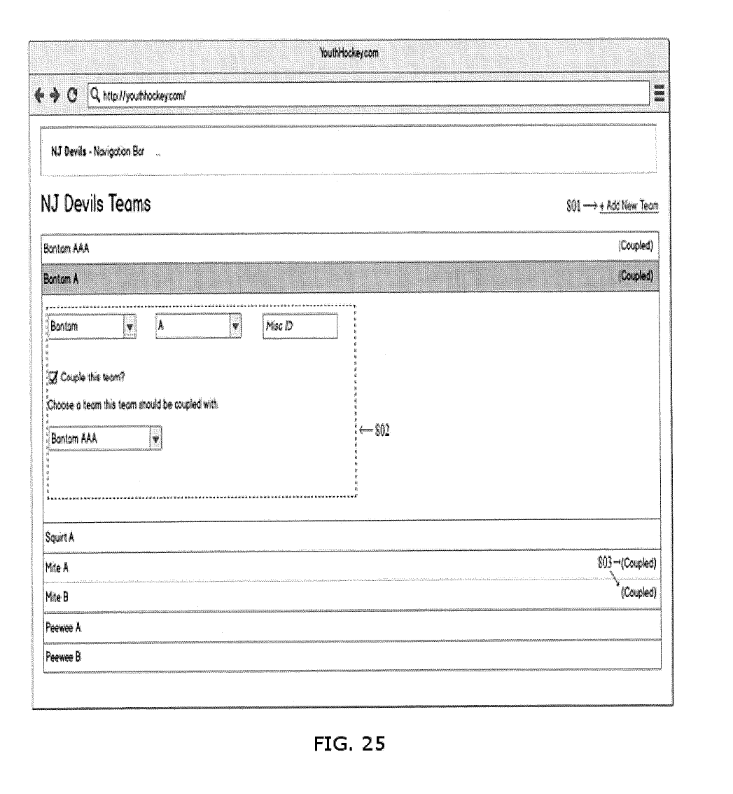

Of course, it should be understood that the process of FIG. 1 is intended to be illustrative only, and that other types of scheduling processes are also possible. As an example of another type of process which could be performed based on this disclosure, consider FIG. 24, which can be used to schedule games on an organization by organization basis. As a prelude to this type of organization level scheduling, an individual with appropriate permissions, such as a manager for the fictitious NJ Devils youth hockey association, would add the teams in his or her organization, and indicate which of those teams should treated as linked [701]. This type of team and link definition [701] could be performed, for example, using an interface of the type shown in FIG. 25. As shown in FIG. 25, the disclosed technology could be used to generate an interface which would allow a manager to, after having added one or more teams (e.g., through an add team control [801]), define links for those teams using a pair-wise link creation tool [802].

In an interface such as shown in FIG. 25, once a link had been defined using the pair-wise link creation tool [802], the teams for which a link had been defined could be identified as such, for example, through the use of “coupled” link identifiers [803] showing that the New Jersey Devils team in the Mite age category and A skill category had been linked to the New Jersey Devils team in the Mite age category and the B skill category. Of course, other types of links (e.g., links between three or more teams, such as could be created through multiple uses of a pair-wise link creation tool [802], or through a link creation tool which would allow a user to select and simultaneously create links between an arbitrary number of teams on a list), or link identifiers (e.g., using color as a link identifier, by displaying each group of linked teams within an organization in a unique color) are also possible, and could be used in the addition of teams and links [701], and so the discussion of how that activity could be performed using an interface such as shown in FIG. 25 should be understood as being illustrative only, and should not be treated as limiting.

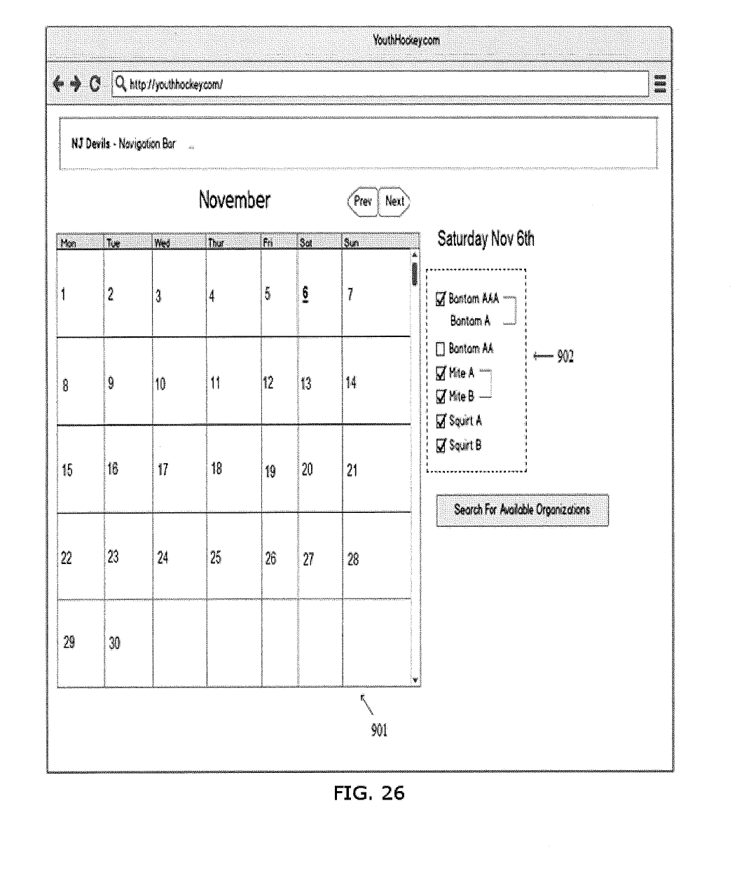

Continuing with the discussion of FIG. 24, in methods of the type shown in that figure, once the teams and links for an organization (referred to in the context of this example as the “scheduling organization”) had been added [701], the method could proceed with the selection [702] of an available day for scheduling matches for one or more teams in the scheduling organization. After the available day had been selected [703], the scheduling process of FIG. 24 could proceed differently based on a check [704] of whether the scheduling organization had any home ice slots available on the selected day. If the scheduling organization did not have any home ice slots available on the selected day, it could be allowed to select [705] which teams should be scheduled to travel on the selected day. An example of an interface which could be used for selection [702] of an available day and selection [705] of teams to travel on that day is provided in FIG. 26.

In the interface of FIG. 26, a user could use the depicted calendar [901] to select [701] the available day on which matches should be scheduled. Once the user had selected [702] a day, the selected day (e.g., Saturday, November 6^{th}) could be highlighted in the calendar, and the computer which generated the interface could make a determination if the organization associated with the user (i.e., the scheduling organization) had any home slots available on the selected day. If there were no home slots available, the interface could be updated with a team selection tool [902], showing the teams which were linked with one another, and allowing the user to choose the individual teams for which travel games would be scheduled on the selected day. As indicated in FIG. 26, a team selection tool [902] could handle links in a variety of ways. For example, it could treat linked teams as a unit, requiring the user to select or deselect them collectively, as shown by the Bantam AAA and Bantam A teams in the exemplary interface of FIG. 26. Alternatively, and also as shown in FIG. 26, a team selection tool [902] could indicate to the user which teams were linked, but allow the user to select or deselect individual teams irrespective of the links between them (e.g., as indicated by the individual check boxes by the Mite A and Mite B teams in the exemplary interface of FIG. 26).

Once the teams to travel with had been selected [704] or, if there were home slots available on the selected day, once the available day had been selected [702], the process of FIG. 24 could proceed with the identification [705] of potential opposing organizations. This identification could be made, for example, by identifying those organizations which had: 1) at least one slot on the selected day matching the travel preferences of the scheduling organization (e.g., if the scheduling organization had no home slots available on the selected day, a potential opposing organization would have to have at least one home slot available on the selected day); and 2) at least one team available to play a team from the scheduling organization (e.g., if the potential opposing organization has a team available to play on the selected date, and that team is in a league with a team from the scheduling organization but has not had all of its league games with the team from the scheduling organization scheduled). Once the potential opposing organizations had been identified, one of those potential opposing organizations could be selected [706] as a candidate for scheduling one or more games on the selected day.

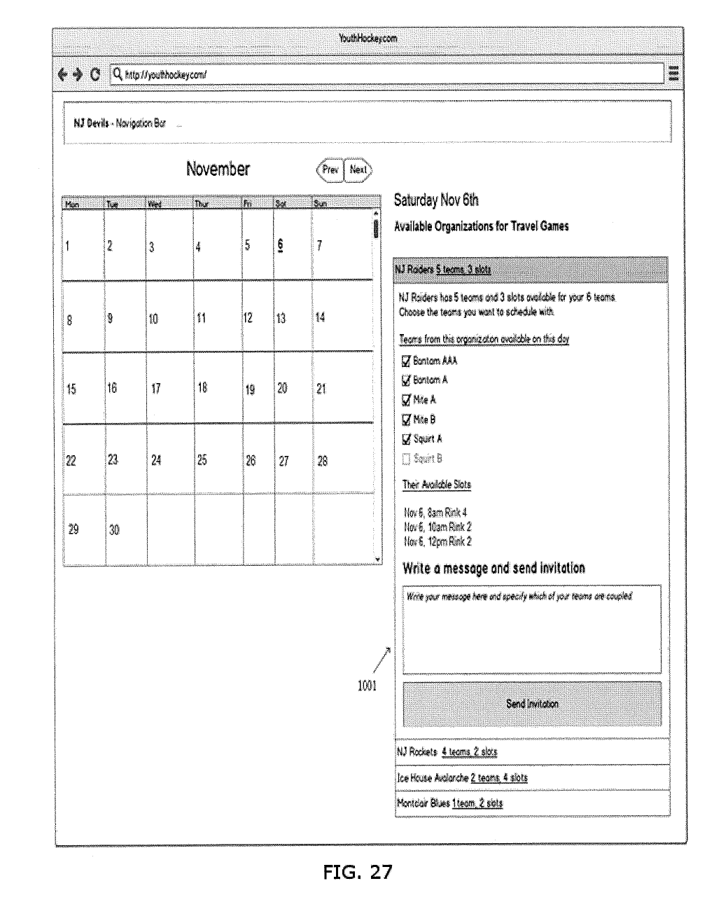

As an example of how the selection [706] of a potential opposing organization could take place, consider the interface of FIG. 27, which would both allow a scheduling organization to select a potential opposing organization, but would also allow the scheduling organization to select [707] which of the potential opposing organization's teams it wished to schedule matches with on the selected day. In the interface of FIG. 27, an invitation creation tool [1001] is shown listing potential opposing organizations from which the scheduling organization can make a selection. As shown in FIG. 27, where such a listing is present it can, for each potential opposing organization, indicate the name of that organization, the number of available teams for that organization, and the number of matching slots for that organization. Once a potential opposing organization is selected from the listing, details for that potential opposing organization, such as its available teams on the selected day, could be shown. The scheduling organization could then use these details, potentially along with controls provided in the invitation creation tool (e.g., the checkboxes of FIG. 27) to identify which teams from the potential opposing organization the scheduling organization would like to schedule matches with on the selected day.

In an interface such as shown in FIG. 27, were potential opposing organizations are identified in, and can be selected from, a list, such a list could be presented in a variety of manners. For example, it could be an ordered list, with the order based on a potential match value set equal to the lesser of the number of matching slots and available teams for that organization on the selected day. Alternatively, potential opposing organizations could be listed in order of the number of matching slots or available teams on the selected day. It is also possible that multiple ordering schemes could be used to provide a mechanism for addressing situations when a single scheme would result in an ordering tie. For example, potential opposing organizations could be placed in descending order of potential match value, with ties between organizations being resolved in favor of teams with a greater total number of matching slots and available teams, further ties being resolved in favor of organizations with the higher number of available teams, and any remaining ties being resolved based on some non-match related criteria (e.g., alphabetic ordering). It is also possible that an interface such as shown in FIG. 27 could vary in other aspects than how potential opposing organizations would be presented. For example, just as a team selection tool [902] such as shown in FIG. 26 could present information on which of the scheduling organization's teams were linked, it is possible that similar information could be presented in an invitation creation tool [1001] for the individual available teams of a potential opposing organization (e.g., by depicting a graphical link between linked teams).

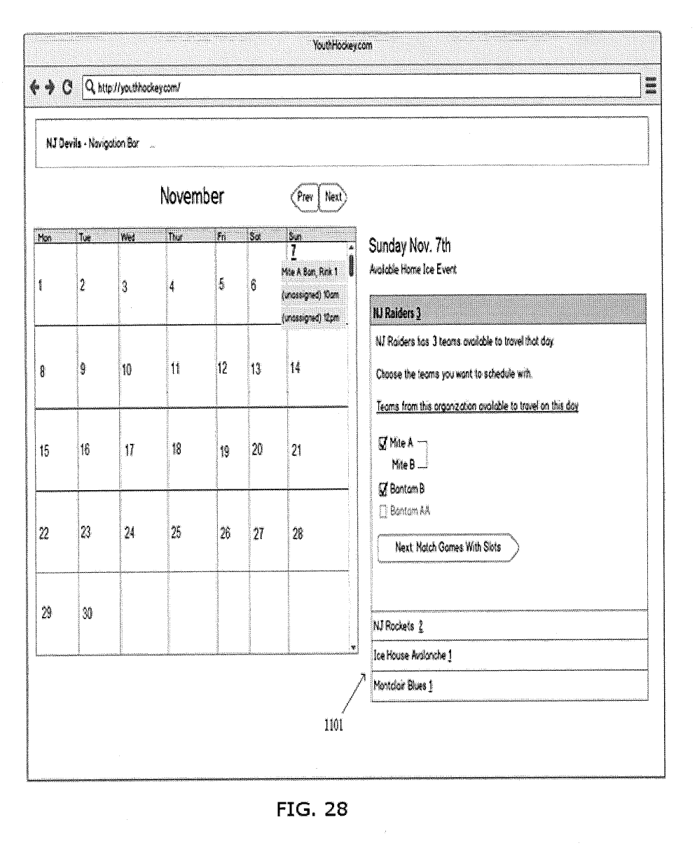

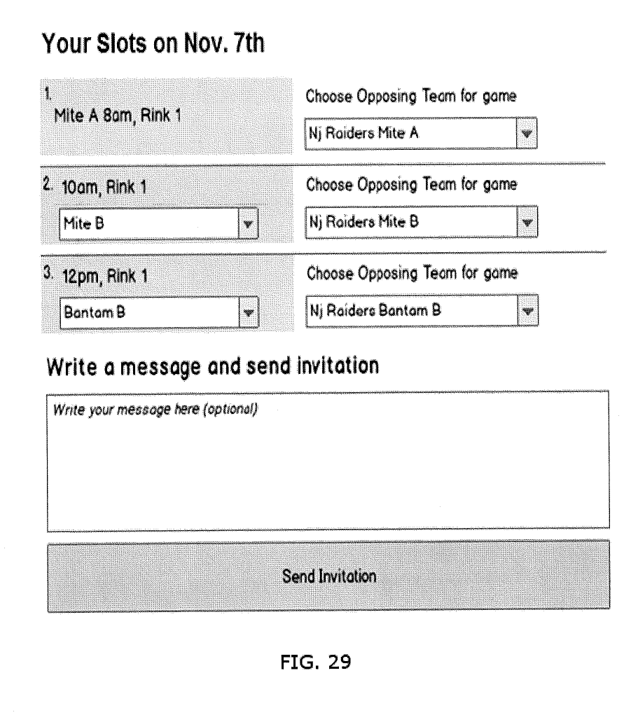

Similarly, just as there could be variations on how an interface such as shown in FIG. 27 could be implemented, it is possible that other types of interfaces could additionally (or alternatively) be supported in systems implemented based on the disclosed technology. For example, FIG. 28 shows an interface with an alternate invitation creation tool [1101] which would preferably be presented when a scheduling organization performing method such as shown in FIG. 24 does have home slots available on the selected day. In that interface, rather than showing both available teams and slots, only the available teams from potential opposing organizations are shown, with potential slots during which games could be scheduled on the selected day (e.g., home slots for the scheduling organization) being indicated using a separate slot matching tool. An example of such a separate slot matching tool is shown in FIG. 29, in which a scheduling organization could quickly see which (if any) of its teams (e.g., Mite A, scheduled for 8 am on rink 1) was already scheduled, and which of its slots on the selected day was open. A slot matching tool could also be used to actually select teams from the scheduling organization and from a potential opposing organization to play games on the open slots for the selected day (e.g., using drop down menus, such as shown in FIG. 29). Of course, it should be understood that a slot matching tool such as shown in FIG. 29 could also be used when creating an invitation using an interface which, like FIG. 27, depicts both available teams and matching slots for a potential opposing organization. Accordingly, the discussion set forth above, in which FIG. 29 was illustrated as being associated with FIG. 28 rather than FIG. 27, should be understood as being illustrative only, and should not be treated as limiting.

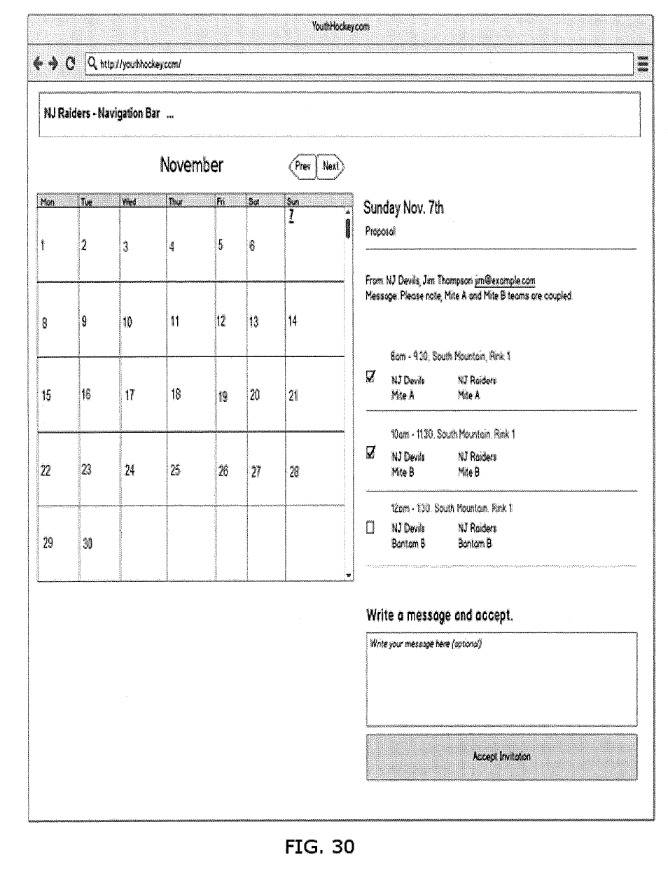

Returning now to the discussion of FIG. 24, in the process depicted in that figure, once an opposing organization and teams from that organization had been selected [706][707], an invitation could be sent [708] to, and accepted or declined [709] by, the selected opposing organization. An example of an interface which could be used by a manager of the selected opposing organization to view and respond to an invitation created by a scheduling organization is provided in FIG. 30. As shown in that figure, such an interface could include indications of each team which the scheduling organization selected for inclusion in the invitation (i.e., the Mite A, Mite B and Bantam B teams from the Raiders), the slots selected for those teams, and a note (such as could have been written in the message fields shown in FIGS. 27 and 29) indicating information the manager of the scheduling organization wished to convey. Also, as shown in 30, an interface which could be presented to a manager of a selected opposing organization could also include controls which could allow that manager to make changes to the invitation. For example, in the interface of FIG. 30, a manager of the NJ Raiders youth hockey association could use the illustrated check boxes to indicate that he or she was only accepting some of the games proposed in the invitation.

After an invitation had been accepted (either with or without modification), the games indicated in the invitation (or whichever of those games were accepted, in the case of acceptance with modification) could be scheduled [710] and, if [711] there were more games to be scheduled for the teams in the scheduling organization, then the manager of the scheduling organization could select [702] another available day to continue scheduling games. Alternatively, if there were no more games to be scheduled for the teams in the scheduling organization, then the scheduling process could be considered finished [712] for that organization, though it should be understood that the scheduling process might still be ongoing for one or more other organizations (e.g., organizations which included teams in leagues which did not having any teams from the scheduling organization).

While FIG. 24 illustrates that it is possible to depart from the process of FIG. 1 when scheduling youth hockey games, it should be understood that similar departures from FIG. 24 are also possible, and will be immediately apparent to those of ordinary skill in the art in light of this disclosure. For example, while the discussion of FIG. 24 indicated that, if a selected potential opponent modified and then accepted an invitation, the games included in the modified invitation would automatically be scheduled, it is also possible that the disclosed technology could be used to implement a system in which modifying then accepting an invitation would be handled by automatically creating a new invitation with the modified terms, sending it to the scheduling organization, and only scheduling games once an invitation sent by one organization had been accepted by another.

Similarly, while the interface of FIG. 30 illustrated a proposal which included both teams a scheduling organization wished to play and slots during which the scheduling organization wished to play them, it is possible that a proposal might leave some information open for a selected opposing organization to fill in when accepting the invitation. For example, an organization wishing to travel on a selected date could be allowed to create a proposal identifying the teams which would be traveling on that date, and inviting a selected opposing organization to identify the slots it had available on that date during which it would be most convenient to play against the traveling teams. Of course, variations which combine processes such as shown in FIGS. 1 and 24, such as systems which support both reciprocal scheduling as shown in FIG. 1, and organization based scheduling, as shown in FIG. 24, or in which invitations for simultaneously scheduling multiple games between organizations such as shown in FIG. 24 are combined with invitations for reciprocal games between those organizations are also possible, and could be implemented by one or ordinary skill in the art without undue experimentation in light of this disclosure. Accordingly, the discussion of FIG. 24 as an alternative to FIG. 1, like the discussions of FIGS. 24 and 1 themselves, should be understood as being illustrative only, and should not be treated as limiting.

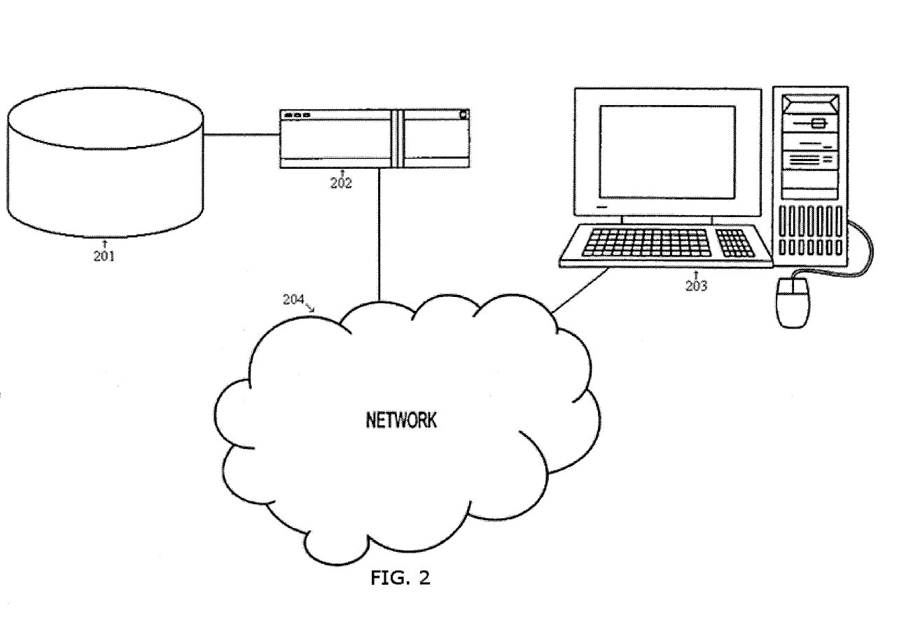

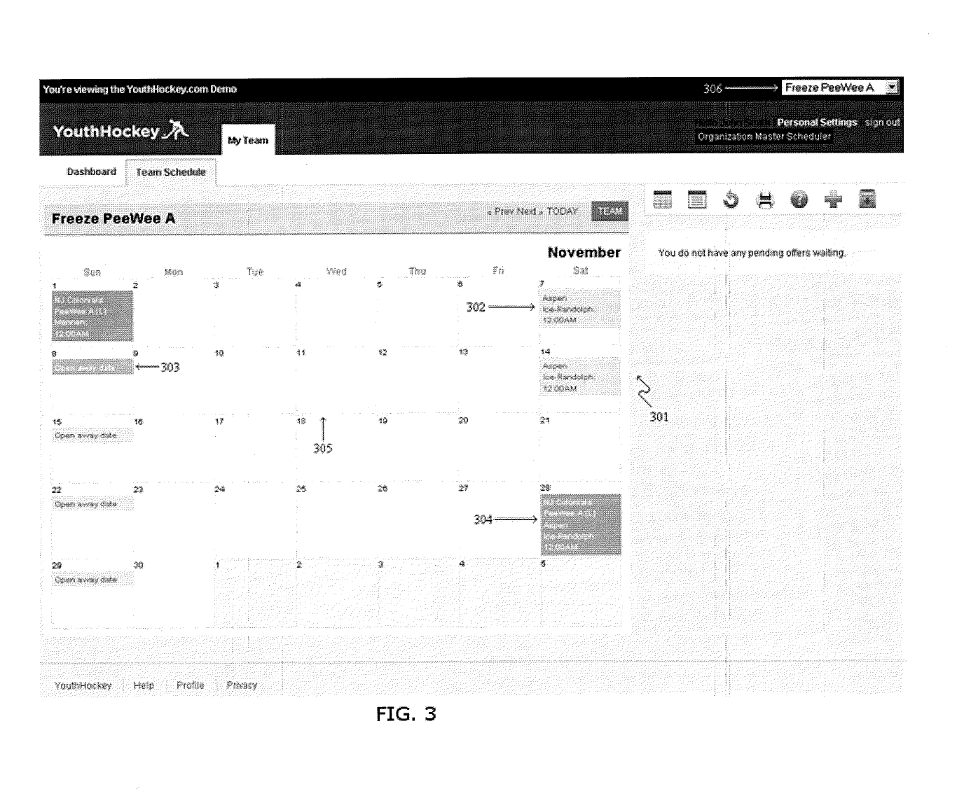

In performing processes such as those described in the context of FIGS. 1 and 24, a number of tools could be used. One such tool is a networked computer system such as shown in FIG. 2. Such a system could operate by storing information regarding the teams in a database [201], then accessing that database using a server computer [202] in response to signals received from a user computer [203] over a network [204]. In some embodiments, the network [204] could be the Internet, and the server computer [202] could be configured to send signals to the user computer [203] which would cause the user computer [203] to display interfaces which would facilitate the scheduling process. FIGS. 25-30, discussed above, and 3-9, discussed below, provide examples of such interfaces, with FIGS. 25-30 showing how a networked computer system such as depicted in FIG. 2 could be used to schedule games on an organization by organization basis, and FIGS. 3-13 showing how a networked computer system such as depicted in FIG. 2 could be used to schedule games on a team-by-team basis.

FIG. 3 depicts an exemplary interface which both displays information about a team's schedule, and allows a user to schedule matches for that team. In the interface of FIG. 3, a calendar [301] is shown which presents the user with a plurality of slots [302][303][304][305] which are either associated with potential events (as shown in the yellow potential home game event [302]), associated with pending events (i.e., offers which can be accepted or declined, as shown in the orange pending slot) [303], associated with scheduled game events (e.g., as shown in the green scheduled game slot [304]), are empty (as shown by the blank slot [305]), or have some other state (e.g., associated with practice events, or with miscellaneous events such as dinners). The interface of FIG. 3 also includes a team selector [306], which could allow the user to view the events slots from the perspective of different teams, depending on the user's permissions and the implementation of any particular system.

In using the interface of FIG. 3, the process of scheduling a match could be initiated by a user selecting a potential event [302], such as by clicking on it, or making some other kind of indication. This could result in a signal being sent over the network [204]. Such a signal could indicate the potential event (or slot) selected by the user, as well as indicating the team associated with the calendar [301] on the interface. Once the server computer [202] receives the indication, it could then process information from the database [201] to identify potential opponents for the team being scheduled. This identification of potential opponents could take a variety of forms, depending on the parameters considered in a particular implementation. For example, if the selected potential event [302] was a potential home game event (as indicated), the server computer [202] could query the database [201] to determine what teams had potential away game events scheduled which had times that started before, and ended after, selected potential home game event [302], and then those teams could be identified as potential opponents. In other implementations, there could be additional filtering. For example, the potential opponents might not only be required to have overlapping potential away game events, but might also be required to not have already scheduled any league games with the team associated with the selected potential home game event [302]. Other implementations, such as those where schedules could be created or modified throughout a season, could use additional or different criteria, such as number of wins, average age of roster, and/or travel distance, to determine what should be considered a possible opponent for the team associated with the selected potential home game event [302].

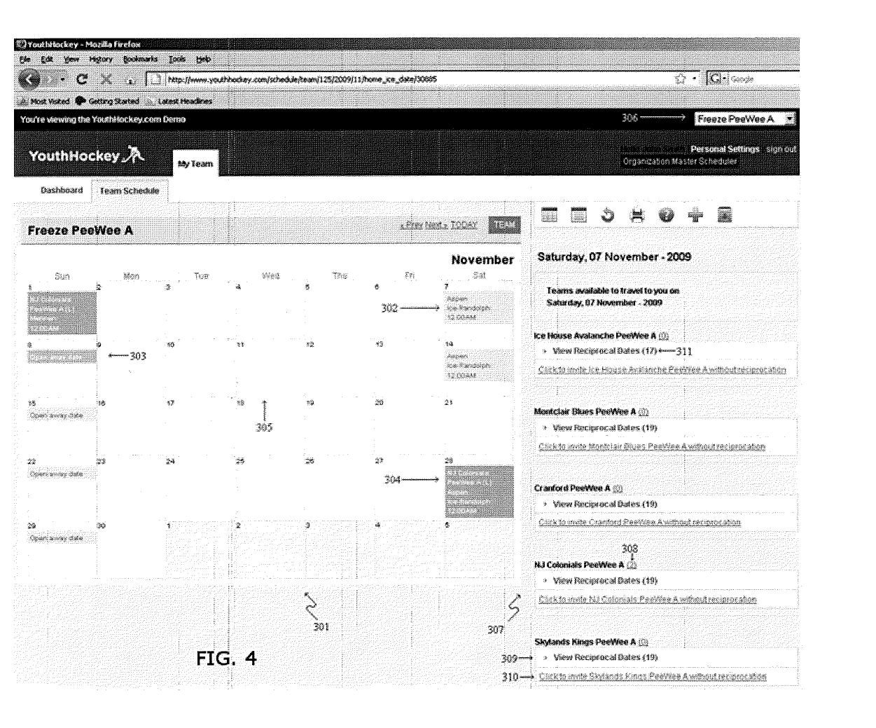

Once the set of potential opponents for the potential home game event [302] had been identified, the reciprocal dates for those potential opponents could be generated to facilitate scheduling of additional games. This could take place by, for each of the potential opponents, identifying the potential home game events for that opponent for which the team associated with the original potential home game event [302] would qualify as a potential opponent (e.g., because of an overlapping potential away game event). With the reciprocal dates determined, a set of data indicating the potential opponents, as well as the number of reciprocal dates for those potential opponents, could be generated and sent to the user computer [203]. While this data could vary between implementations, in some cases, it could comprise instructions which would cause the display of the user computer [203] to be updated, such as to show an interface of the type depicted in FIG. 4. In the interface of FIG. 4, there is a listing of potential opponents [307], where each potential opponent is listed along with an indication of currently scheduled games [308], an option for viewing the reciprocal dates for the opponent [309], an option for making a match invitation without reciprocation [310], and (within the option to view reciprocal dates [309]) an indication of the number of reciprocal dates for the potential opponent [311].

Note that, as demonstrated in the interface of FIG. 4, the information regarding potential opponents can be presented to the user in such a way as to facilitate the selection of an opponent for the potential home game event [302]. For example, in FIG. 4, the set of potential opponents is displayed so that the opponents where scheduling is most constrained (e.g., those with the fewest reciprocal dates) are presented at the top of the list so that the user can schedule them first, while leaving the less constrained opponents until later which, in some cases, can lead to significant efficiencies in scheduling for teams with limited flexibility in ice slots.

Variations on this theme are also possible. For example, in some implementations, once a match had been scheduled between two teams, those teams would automatically be moved to the bottom of the list, so that the user could focus his or her attention on the still unscheduled teams. Similarly, in some cases the potential opponents might be displayed with an indication of distance between teams (e.g., as indicated by driving distances between home ice for the team being scheduled and its potential opponent) so that a coach could select games with teams that are closer in preference to teams which are farther away.

Of course, it should be noted that this additional information is not limited to being displayed in an interface such as shown in FIG. 4. For example, in different embodiments, rather than displaying this additional information, the additional information could be considered when determining the set of potential opponents itself (e.g., for an evening game, a team located more than 100 miles away is not to be considered a potential opponent, or the estimated driving time could be appended to the time of the game for the potential home game so that the comparison with the potential away game event would include an accurate reflection of the time required for the visiting team).

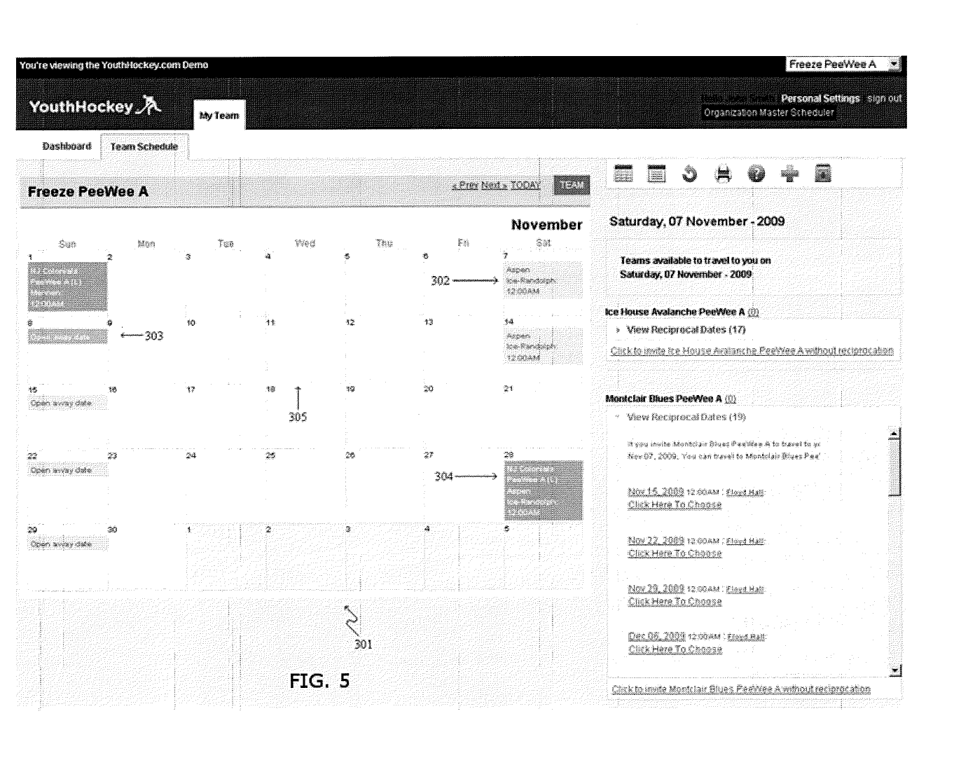

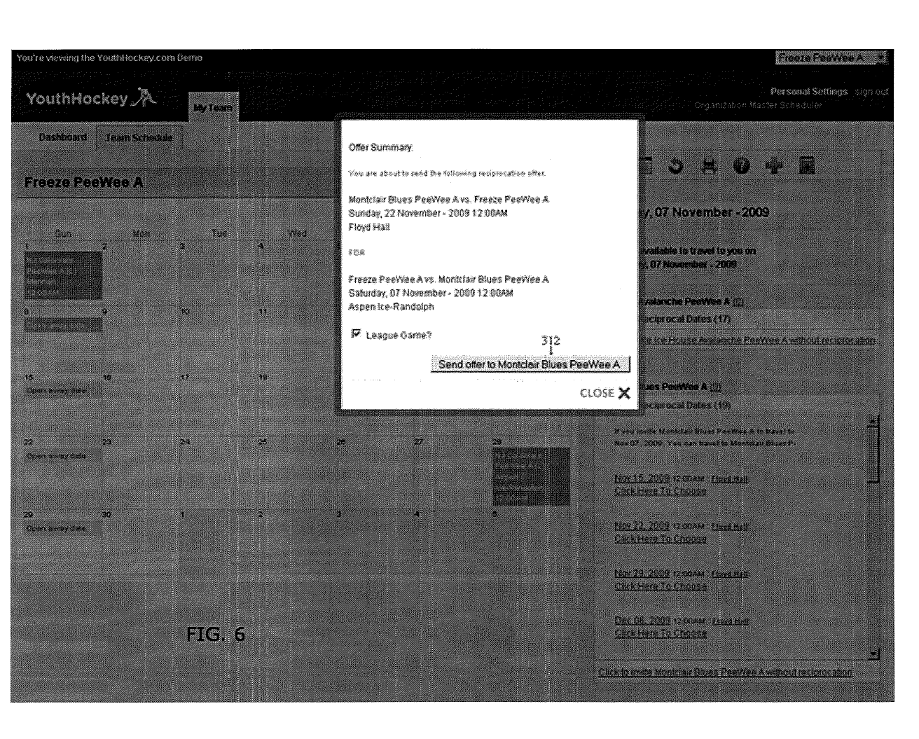

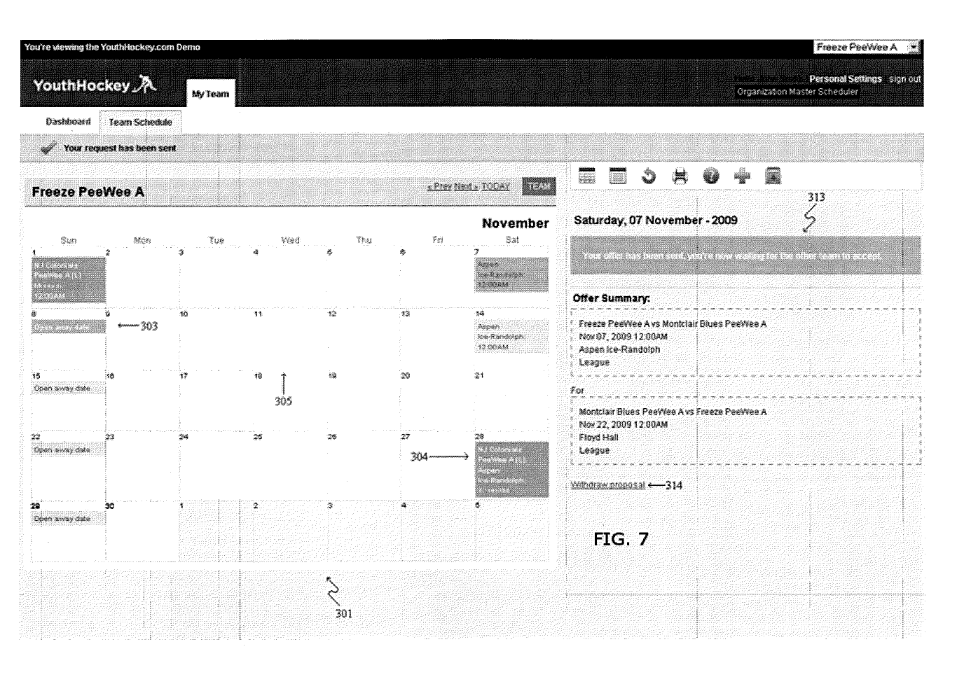

Also, it should be understood that, while FIG. 4 illustrates an interface which could be presented after a set of potential opponents had been determined, the set of data sent to determine that interface could also include information beyond that displayed in FIG. 4. For example, the set of data could include information which could allow the user to view the reciprocal dates for a potential opponent (e.g., using an interface as shown in FIG. 5) without requiring further communication between the server computer [202] and the user computer [203] once a particular potential opponent is selected. This information could also allow the user to select one of the reciprocal dates, and confirm that the user wished to schedule a game for that date (e.g., using an interface with a confirmation form [312] such as shown in FIG. 6). Once the confirmation had taken place, the interface could again be updated, such as shown in FIG. 7, this time with a confirmation message [313] showing the times of the proposed match for the potential home game event and the selected reciprocal date, as well as with a tool [314] which could allow the user to withdraw the invitation before it was accepted.

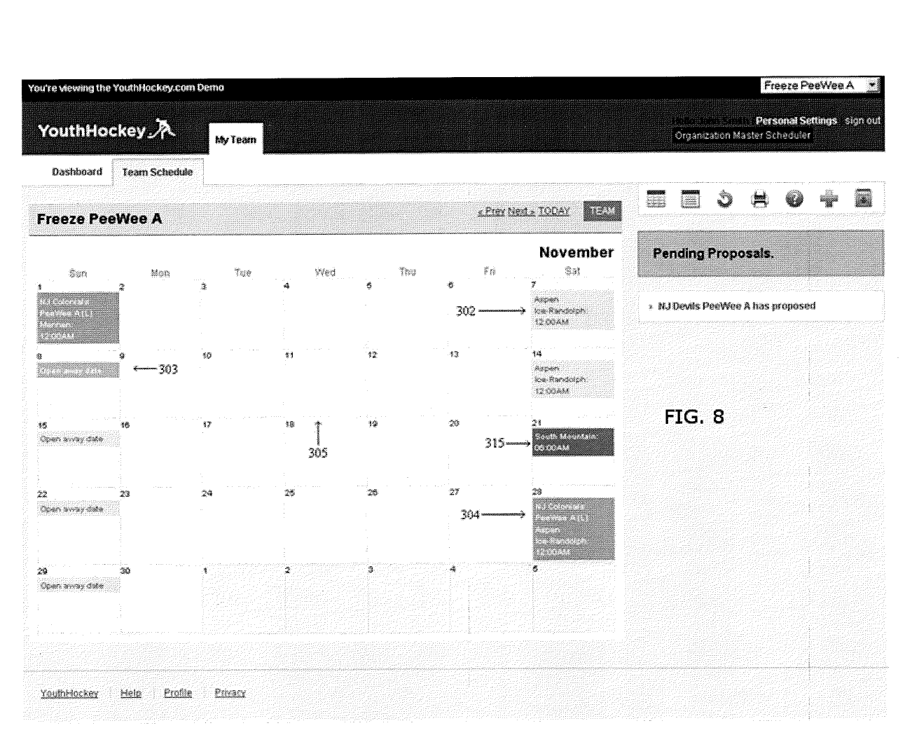

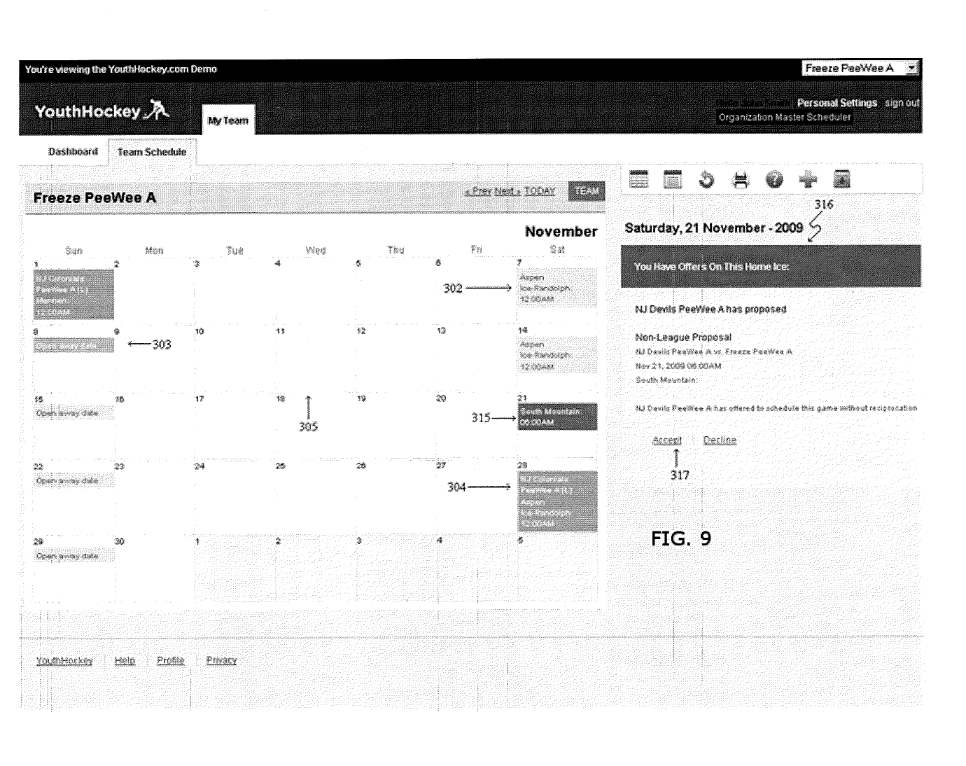

After an invitation had been sent, the final step in scheduling a match (or reciprocal matches, in the scenario where a reciprocal date had been selected) would be for the potential opponent to accept the invitation. This could be facilitated by, when the selected opponent views his or her calendar, including in that calendar a pending proposal slot [315], such as shown in red in FIG. 8. When the user selected the pending proposal slot [315], the interface presented could be updated as shown in FIG. 9 to include proposal details [316], and a tool [317] allowing the user to accept or decline the proposal. If the proposal were accepted, then a signal to that effect would be sent to the server computer [202] over the network [204], and the server computer [202] would update the database [201] showing that the proposal was accepted and was now a scheduled game. The interface presented to the user could also be updated, such as by replacing the red proposed game event [315] with a green slot showing a scheduled game. This process could then be completed for each of the team's open slots, until each of those slots had been scheduled.

Of course, it should be understood that the discussion above is intended to be illustrative only, and that modifications on the above disclosure are contemplated by the inventors and will be immediately apparent to those of ordinary skill in the art. For example, the example in the above disclosure addressed a situation where a home game event was scheduled by selecting a potential home game event and identifying opponents with potential away game events starting before, and ending after, the potential home game event. However, some implementations could be created to support the opposite approach—where a home game event would be scheduled by selecting a potential home game event and identifying opponents with potential away game events starting after, and ending before, the potential home game event. Similarly, while the above disclosure focused on situation where events are associated with particular teams, it is possible that some implementations might support events for teams that have yet to be determined. For example, there could be an implementation where a master scheduler for an entire league would be able to schedule a tournament or playoff game event in advance by setting information such as location, time, and referees, but would only associate that event with individual teams once it was clear who would be participating in the tournament or playoff.

Combined approaches are also possible. While many organizations purchased ice from a rink and then schedule, a few rink owners also run their own travel organizations and therefore have greater flexibility in scheduling. In such a case, the rink may preassign slots to hockey games or allow for games to be played any time during their business hours (with or without limitations). In such a case, the team might be assigned a potential TBA (To Be assigned) home game event, to represent the team both has ice available for a home game, and that it could potentially travel on that date. In terms of matching for reciprocal ice, potential to be announced home game events could be treated as either potential home games, or as potential away games, depending on the availability of opponents on any given day. In some implementations, a system could allow for many teams to use TBA's slots for the same day, with allotment of home slots assigned on a first come first serve basis, with or with out limitations. For example 10 teams can designated a day TBA with only 4 TBA's available. Once the four slots are scheduled the remaining TBA's on that particular day would become available travel dates. In addition, each team can be restricted to a specific number of TBA home slots. So a team can be allocated 10 TBA's but designate 30 days as TBA's, but once a team uses it s allotment, the remaining potential to be announced home game events could be converted into potential away game events, and scheduling could continue as normal.

Further variations, such as implementations where multiple events are scheduled on single days (e.g., one day could have both a potential to be announced home game and a potential away game event scheduled), or where scheduling gives preference to certain types of events (e.g., for matching reciprocal ice, events based on set blocks of time could be scheduled before more flexible events). Accordingly, the discussion above of potential to be announced home game events, as well as how they could be incorporated into a scheduling system, should be understood as being illustrative only, and not limiting.

Regardless of the types of events and matching techniques used in a particular implementation, as described above, a schedule for a youth hockey league could be easily created by repeating the selection/invitation/acceptance cycle until a team's entire schedule was defined, then moving on to the next team and repeating for each team. However, the described approach is just one in which the teachings of this disclosure, including the automated identification of reciprocal dates, could be used to generate a schedule for youth hockey league. For example, in some implementations, instead of relying on scheduling home and away games simultaneously using reciprocal ice, the balance between a games home and away events could be maintained using a location bank. To illustrate this approach, consider the case of a league which is run on a single round robin (i.e., each team plays each other team one time) or power matched (i.e., teams are separated into groups based on results, and play other teams in the same groups) schedule. In such a case, the same types of interfaces as described above could be used to schedule games, with a slot being selected, potential opponents being identified, and invitations being sent. However, when an invitation is sent, instead of identifying a reciprocal date for the same opponents, a counter or other type of tracking variable could be incremented (or decremented) to show the current balance of home games versus away games for the scheduled opponents. Then, when the next game is scheduled, if the team being scheduled had a positive balance (indicating more away games than home games), the event scheduled for that team would be a home game, while if the team being scheduled had a negative balance, the event scheduled for that team would be for an away game, rather than for a home game. Other systems, such as those identifying values other than hosting games and incorporating them into the location balance, could also be implemented. Accordingly the discussion above the team-by-team approach with reciprocal invitations should be understood as being illustrative only, and not limiting.

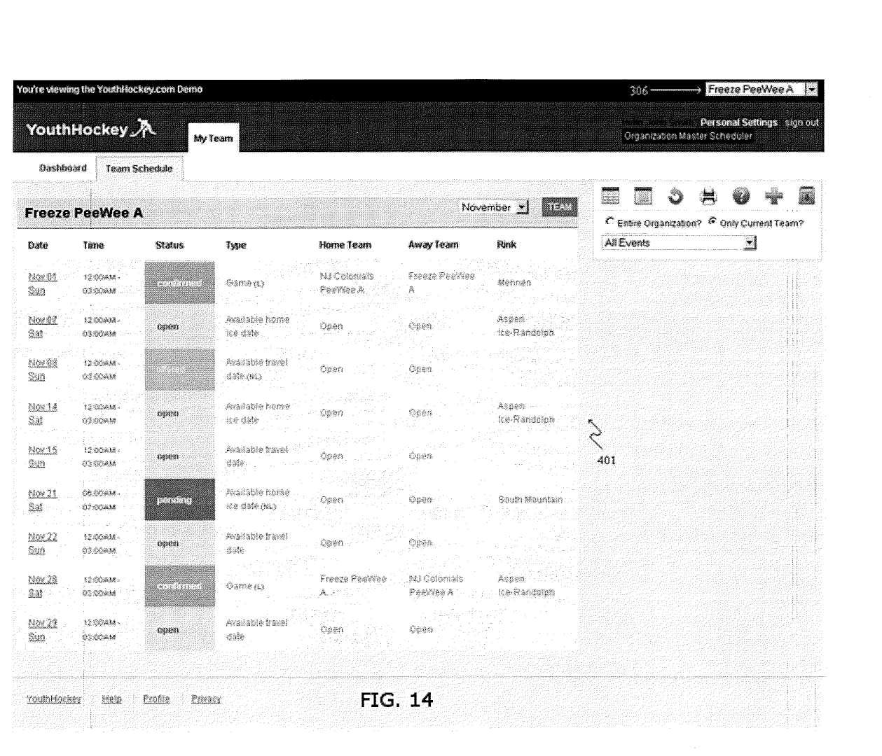

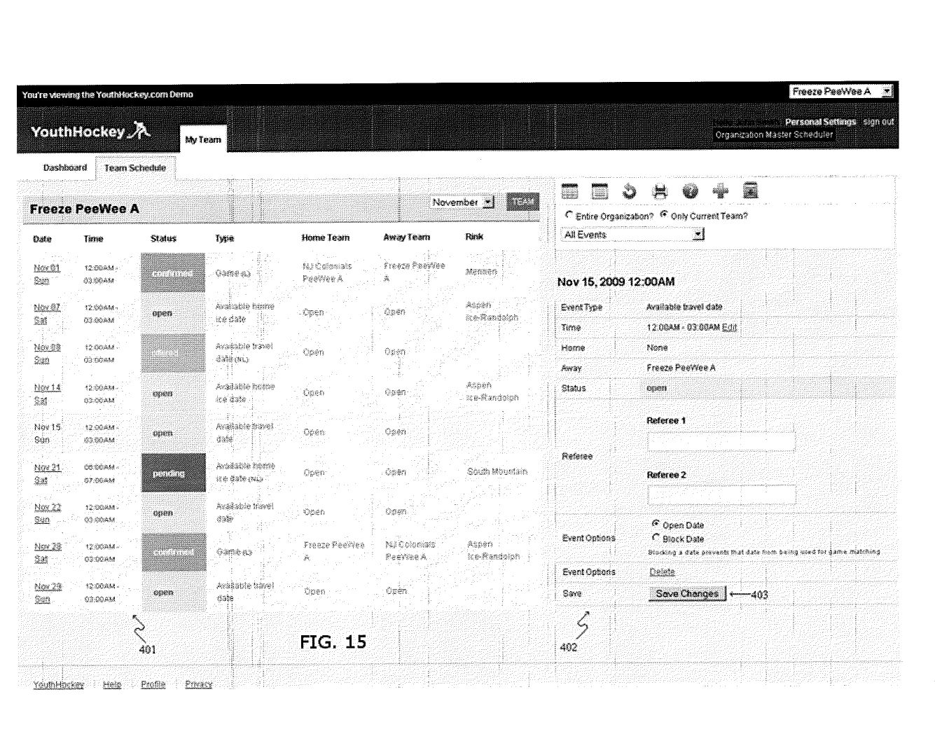

Other types of variations are also possible. For example, while the above disclosure focused on the use of calendar interfaces such as shown in FIGS. 3-13, it is possible that other interfaces could be used either in addition to, or as alternatives to, the calendars discussed above. For example, FIG. 14 depicts an interface which presents event slots such as shown in FIG. 9 in a list [401]. Such an interface could be configured to allow a user to perform actions similar to those discussed previously (e.g., accepting invitations, scheduling reciprocal ice), or could be configured to provide different or additional functionality to the user. For instance, a list interface could be configured such that when a user selects an event, the interface would be updated as shown in FIG. 15, such that a set of editing forms [402] and a save tool [403] would be presented to the user. As shown in FIG. 15, the editing forms [402] could allow the user to change information about an event, such as times associated with that event, whether the event is available for a game, and whether the event should be deleted. Additionally, other functionality beyond that shown in FIG. 15 could also be included. For example, in a case where a user is responsible for multiple teams, that user might have the ability to select a home event assigned to a first team, and reassign it to a second one of the teams he or she was responsible for. Once the edits had been made, the save tool [403] could be used to allow the user to indicate that editing for the event was complete. This save tool [403] could be programmed to send a signal to the server computer [202] which would cause the server computer [202] to update the database [201] with the changes the user had made.

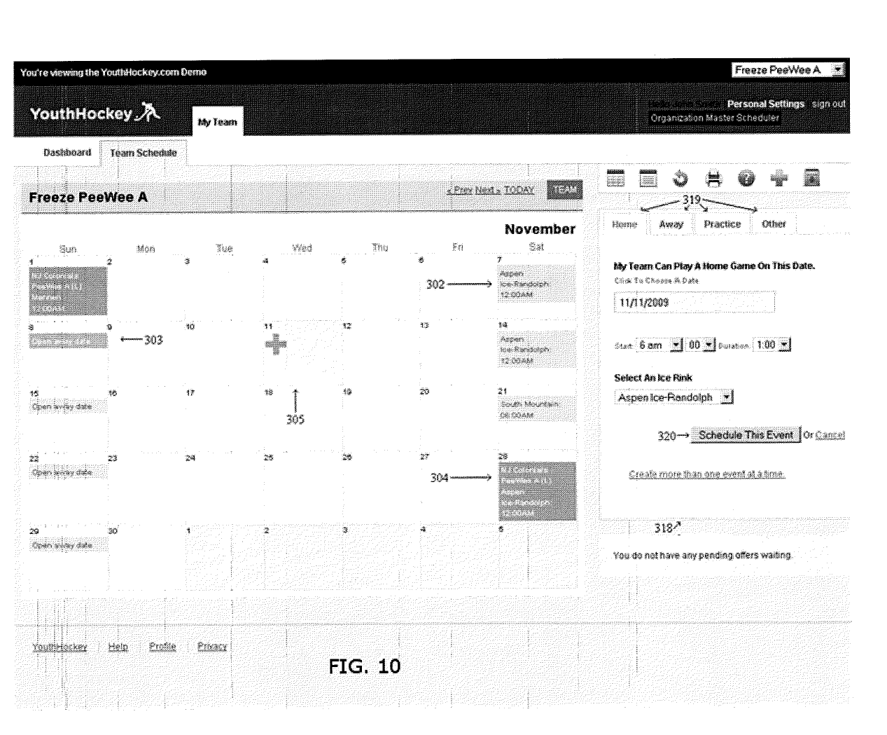

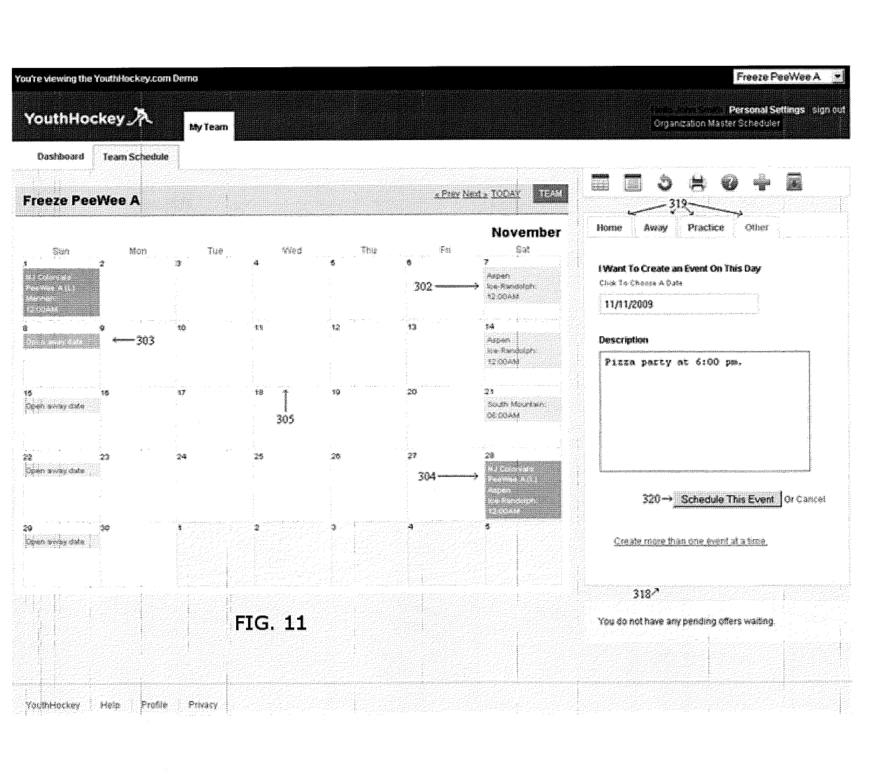

Of course, it should be understood that the discussion above is not meant to imply that calendar interfaces such as shown in FIGS. 3-13 cannot be used to modify events, or that list interfaces such as shown in FIGS. 14-15 cannot be used to create invitations or schedule reciprocal ice. It is possible that in some implementations a calendar (or list) interface could allow both editing of events and creation/acceptance of invitations, potentially accompanied by additional functions as well. Also, while the above disclosure focused on scheduling events which were already allocated for games (e.g., potential home game events), it should be understood that systems implemented following the teachings of this disclosure are not limited to those which only manage pre-existing events. For example, in a calendar style interface such as discussed above with respect to FIGS. 3-13, if a user selects a blank slot [305], then he or she might be presented with an event creation tool [318] such as shown in FIG. 10. As shown in FIG. 10, the event creation tool [318] can be implemented to include a plurality of tabs [319] which allow the user to select whether the event to be created is a (potential) home or away game, a practice, or some other type of event. With these tabs activated, the user can set information for particular types of events. For example, in FIG. 10, the home game tab is activated, and tools are presented so the user can identify the date, time and location for a game that would be considered a home game for purposes of reciprocal ice and league scheduling. Similarly, FIG. 11 illustrates an interface which allows the user to create a miscellaneous type event, accessed using the “Other” tab. Once the information had been entered, the user could activate the “Schedule Event” form [320], which would cause the information related to the newly scheduled event to be sent to the server computer [202] and stored in the database [201].

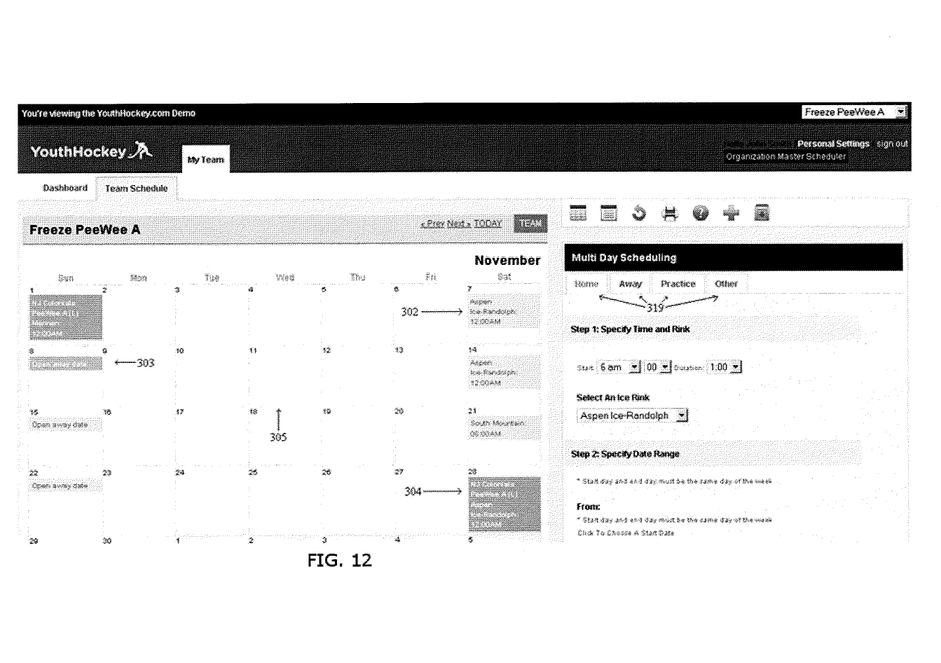

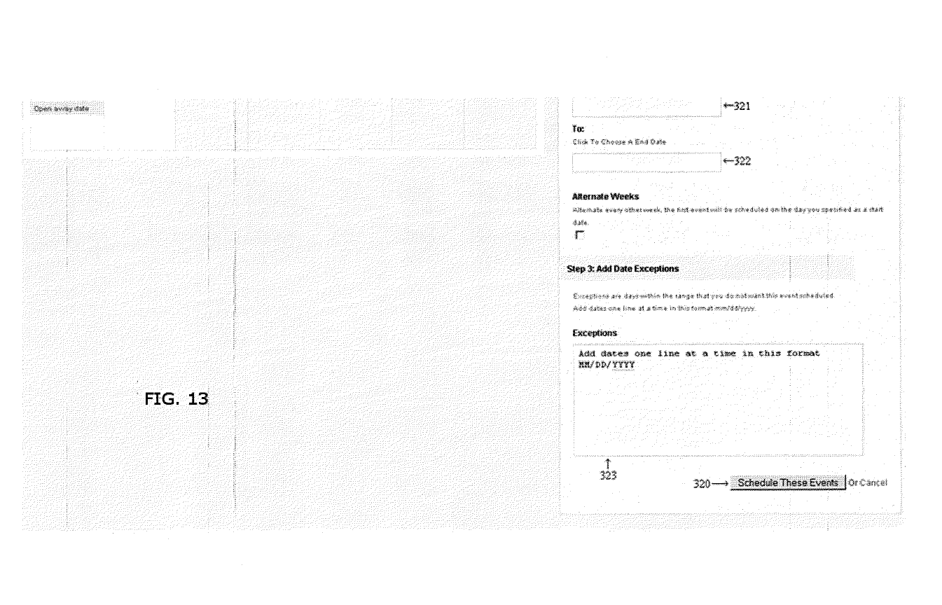

As is the case with scheduling games, variations on scheduling events (e.g., potential home or away games) are also possible. As an example of this, consider FIGS. 12 and 13, in which the combination of those figures with the bottom of 12 connected to the top of 13 depicts an interface which can be used to schedule weekly repeated events. In those figures, a user can use the start [321] and stop [322] date controls to indicate the time period over which the repeated events will take place. The user can also identify dates which should be excluded from the repeated event schedule by entering a list of such dates into the exclusion form [323]. Thus, if a user wished to schedule potential home game events every Friday between Nov. 6, 2009 and Jan. 29, 2010, but excluding Christmas and New Year, the user could enter Nov. 6, 2009 into the start date control [321], Jan. 29, 2010 into the stop date control [322], and Dec. 25, 2009 and Jan. 1, 2010 into the exclusion form [323]. Similarly, approaches to scheduling other types of repeated events (e.g., practices, away games) could be used by selecting the tab [319] to indicate the type of repeated event to be scheduled. Other types of variations, such as scheduling repeated events on other than a weekly basis (e.g., practice every weeknight) could also be implemented. Accordingly, FIGS. 10-13, as well as the accompanying disclosure, should be understood as being illustrative only, and not limiting on potential implementations of the inventors' technology.

Additional functionality, beyond adding and scheduling events could also be included in systems implemented using aspects of this disclosure. For example, in addition to (or as an alternative to) data regarding scheduling, a database [201] such as shown in FIG. 2 could also include information specific to the games and players who participated, such as a game score, number of goals or assists for a player, a player's contact information, cumulative goals scored by and against a given team, or other information which could be appropriate for a given application. As another example of additional functionality, some systems might identify different user roles, and provide users with different data access and modification rights based on their role. To illustrate this concept, consider a case, discussed below, where users are assigned one of three roles: master scheduler, team manager, and player.

In a case where users had roles of master scheduler, team manager and player, the master scheduler could be given the broadest access rights. For example, the system could be implemented so that only the master scheduler would have the right to schedule league games. The master scheduler might also be responsible for initially scheduling potential home and away games for the teams in a league, such as by using tools such as described above with respect to FIGS. 10-13. The team manager could then be presented with a reduced set of functionality. For example, in some implementations, a team manager could schedule non-league games (perhaps only after all league games had been scheduled), but might not be able to schedule games for the league itself. Similarly, a team manager might be limited to accessing (or modifying) information related to his or her own team, while the master scheduler might be given broader access (or modification) privileges, such as privileges covering an entire league, or covering an entire set of teams making up an organization (e.g., multiple Freeze teams for players of different age levels). Players might be given an even more reduced set of functionality. For example, a user with the role of player might be limited to view only access, such as being able to view, but not modify, the league schedule or statistics. Further, in a manner similar to that described above regarding limiting team managers to only accessing (or modifying) data related to their own team, in some cases a user with the role of player might only be able to view his or her own statistics, rather than viewing the statistics of other players or players on other teams.

Of course, variations on the above rights allocations are possible. For example, in some cases, rather than limiting the ability to assign home or away events to the master scheduler, there might be functionality which would allow team managers to allocate new events, such as if they purchase time directly from a rink. Similarly, in some cases, rather than requiring a master scheduler to allocate events as home or away, a system could be programmed to initially create a random allocation of home and away games (balanced between home and away for any one team), which would both remove that administrative burden from the master scheduler, and avoid potential charges that events were allocated due to favoritism. As yet another variation, in some cases a system could be implemented with different roles than described, such as by including only players and team managers, but omitting master schedulers. In such a case, initial home and away events could be purchased by the organization and allocated randomly to the teams, and the team managers would be responsible for scheduling both home and away games, such as by using interfaces such as discussed herein. Variations with more roles, such as roles for parents or coaches are also possible. Accordingly, the above discussion of roles using the master scheduler, team manager and player roles should be understood as illustrative only, and not limiting.

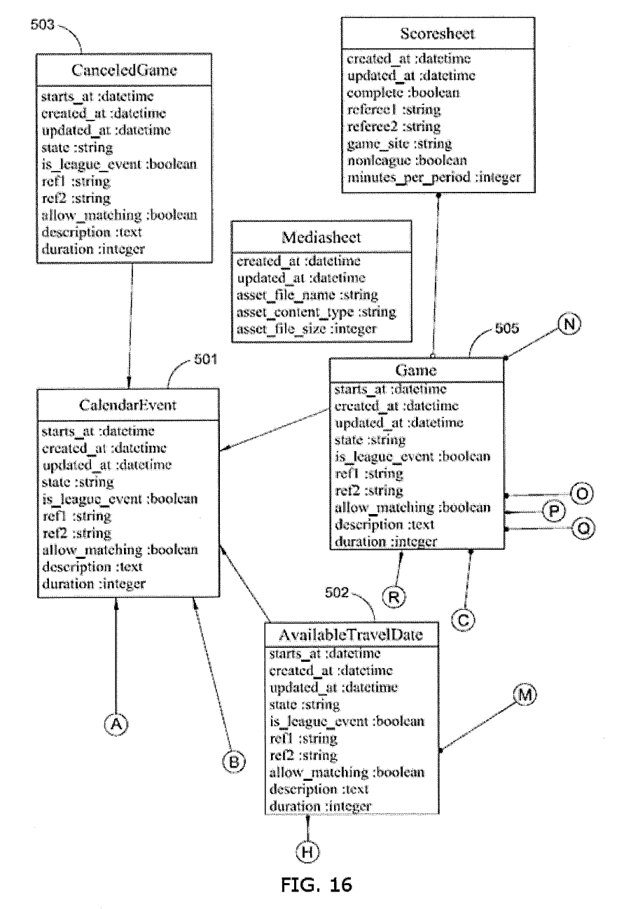

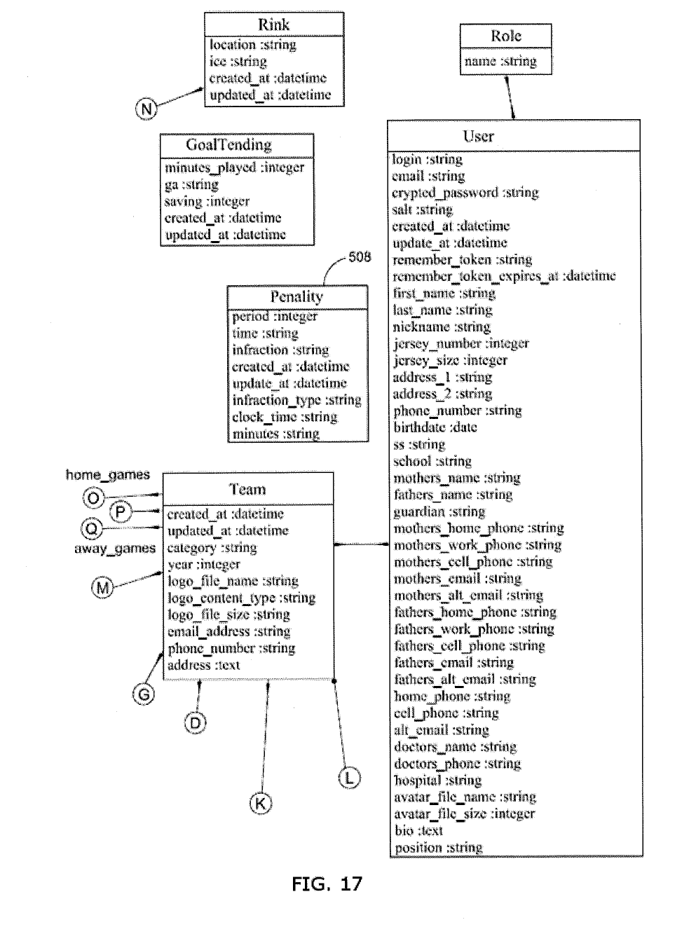

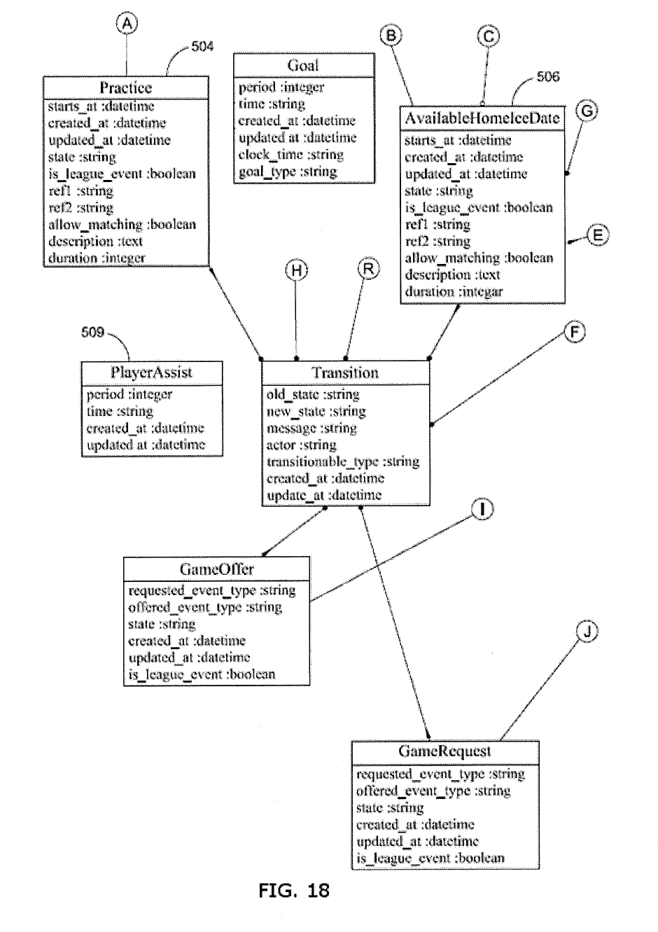

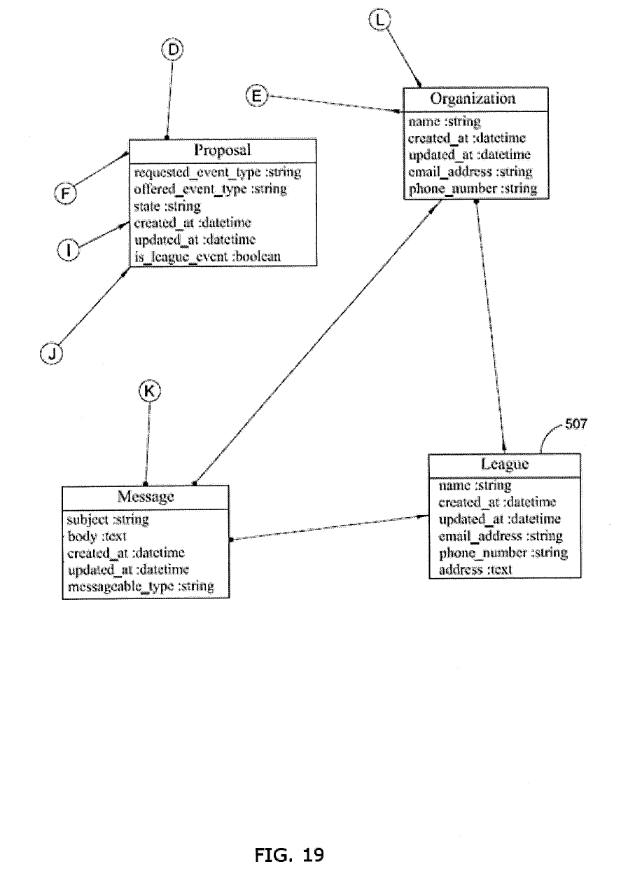

There could also be variations on how underlying systems and data models could be used and implemented to provide functionality such as described. For example, some implementations might follow the popular model-view-controller architecture, in which information in the database [201] could follow a data model such as depicted in FIGS. 16-19, in which those figures could be combined to form a single figure with FIG. 16 in the upper left quadrant, FIG. 17 in the upper right quadrant, FIG. 18 in the lower right quadrant, and FIG. 19 in the lower left quadrant. In that model, different slots, such as depicted in the calendar interface of FIG. 3 could be represented by a base CalendarEvent [501] data type, which could be specialized into AvailableTravelDate [502], CanceledGame [503], Practice [504], Game [505], and AvailableHomeIceDate [506] derived data types. As a further illustration of how such a model could be implemented, the computer program listing appendix submitted herewith contains files which could define and cause a computer to implement aspects of such a model.

Of course, it should be understood that variations on the specific data types depicted in FIGS. 16-19 are possible. For example, in an implementation which supports events which represent extended time periods during which events can be scheduled, there could be a TBAEvent type, similar to (or perhaps as an extension of) the CalendarEvent [501] type depicted. Such a TBAEvent type could include data members such as individual slots into which the larger time period is divided up, restrictions on assignments for slots (e.g., games or practices for peewee teams might be limited to afternoon slots), exception periods during which an event could not be scheduled, and other data as appropriate in a particular implementation. Additionally, different systems could also track data not depicted in the data model of FIGS. 16-19. For example, there might be a case where there are different types of slots, such as slots represented by TBAEvents, and slots represented by CalendarEvents [501]. In such a case, if one type of slot is seen as more desirable than another (e.g., TBAEvent slots might be seen as more desirable due to their flexibility) a system could track how many of the more desirable slots had been used by a particular team or organization, and prevent that team or organization from overusing the more desirable slots once some threshold utilization of those slots had been reached (e.g., the system could initially display all of an organization's TBAEvents for a team, but once the team had used a threshold number of TBAEvents for scheduling, no further use of TBAEvents would be allowed, even if there were still TBAEvents available for other teams in the organization).

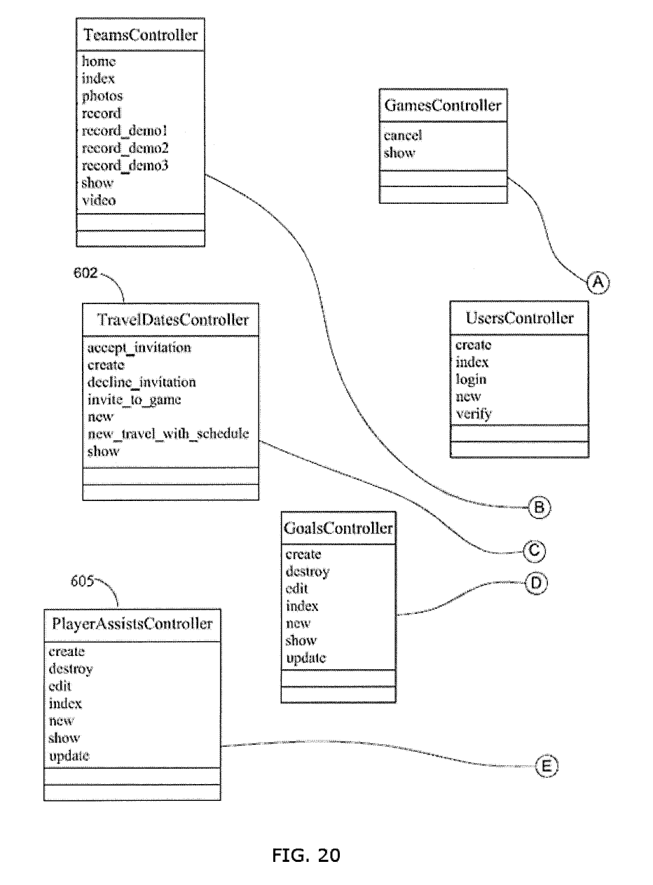

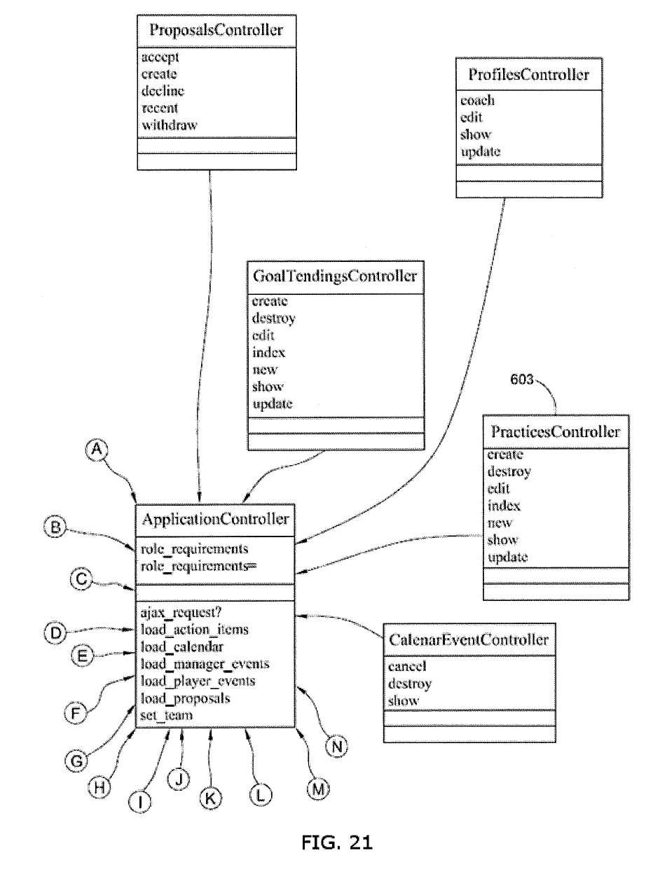

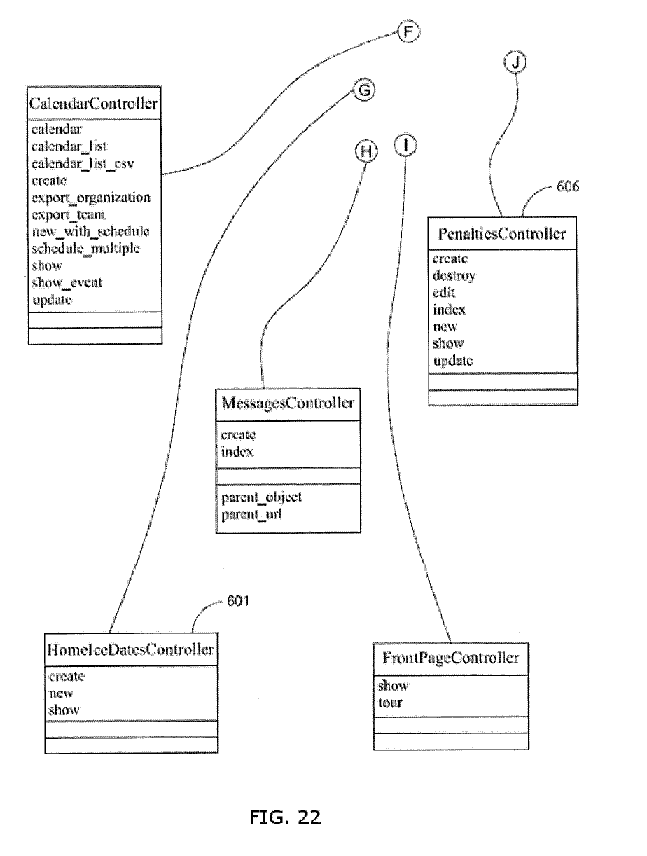

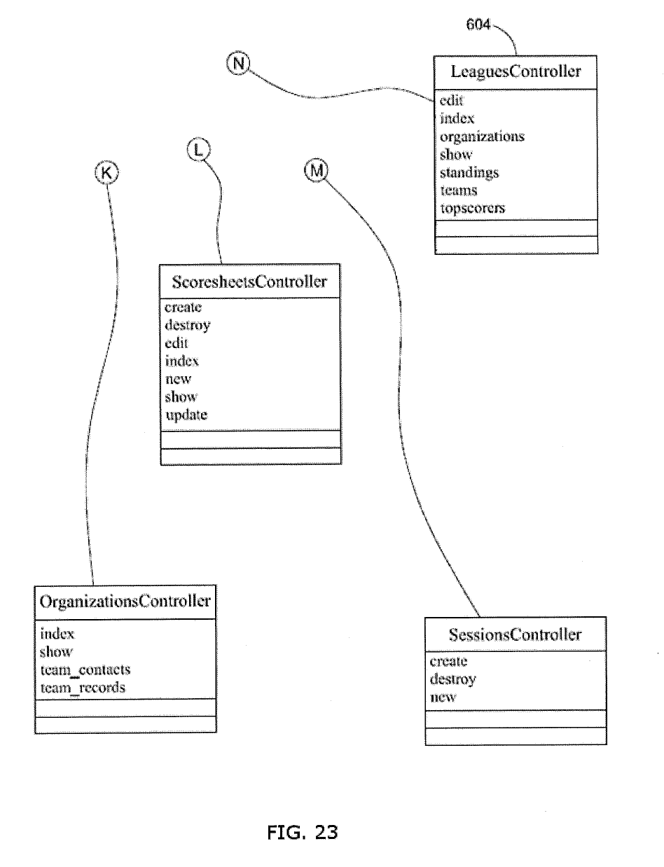

Whatever approach is used to store data, with a data model defined, new events could be created and scheduled could be scheduled using appropriate controllers as shown in FIGS. 20-23, which could be combined in the same manner as FIGS. 16-19 to form a single figure. These controllers could include a HomeIceDatesController [601], which could be used to create new data objects of the AvailableHomeIceDate [506] type. There could be similar relationships between the AvailableTravelDate [502] type and the TravelDatesController [602], and the Practice [504] type and the PracticesController [603]. Other controllers could also be used to perform administrative functions. For example, the LeagueController [604] could be used to create new objects of the League [507] data type, thereby allowing multiple leagues to be run from a single database [201] in a system such as shown in FIG. 2. Similarly, a PlayerAssistsController [605] and a PenaltiesController [606] could be used to create new objects of the Penalty [508] and PlayerAssist [509] data types, thereby facilitating the maintenance of statistics.

Finally, the views through which the data in the model could be presented could then be implemented in code that would execute on the user computers [203], to present interfaces such as previously described. Examples of this type of code can be found in the computer program listing appendix submitted herewith. In that appendix, SourceFile1.txt corresponds to code which could be sent to a user computer [203] to cause an interface such as shown in FIG. 3 to be displayed. SourceFile2.txt corresponds to code which could be sent to a user computer [203] to cause an interface such as shown in FIG. 4 to be displayed. SourceFile3.txt corresponds to code which could be sent to a user computer [203] to cause an interface such as shown in FIGS. 12 and 13 to be displayed. SourceFile4.txt corresponds to code which could be sent to a user computer [203] to cause an interface such as shown in FIG. 14 to be displayed.

While the above discussion focused on implementations in which games for a youth hockey league were scheduled using automatic identification of reciprocal dates, it should be understood that the disclosure set forth herein is not limited to being implemented in the manners explicitly described. For example, the approaches described herein could be applied in other settings where reciprocal scheduling might take place (e.g., adult sports leagues where playing away games might entail significant travel) or might implement other aspects of this disclosure (e.g., disclosed user roles, or approaches to creating events). Additionally, various aspects of this disclosure (e.g., the invitation/acceptance approach, the data models, etc) might be used in systems which do not include automatic reciprocal scheduling. Accordingly, instead of limiting the protection accorded by this document, or by any document which is related to this document, to the material explicitly disclosed herein, the protection should be understood to be defined by the following claims, which are drafted to reflect the scope of protection sought by the inventors in this document when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to the claims based on the above disclosure or the incorporated priority documents is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect.

### EXPLICIT DEFINITIONS

When used in the claims, “cardinality” should be understood to refer to the number of elements in a set.

When used in the claims, “computer” should be understood to refer to a device, or group of devices, which is capable of performing one or more logical and/or physical operations on data to produce a result. Non-limiting examples of “computers” include servers, laptops, desktops, netbooks, and notebooks, as well as handheld devices such as cellular phones, personal digital assistants, and portable game consoles.

When used in the claims, “computer executable instructions” should be understood to refer to data which can be used to specify physical or logical operations which can be performed by a computer.

When used in the claims, “computer readable medium” should be understood to refer to any object, substance, or combination of objects or substances, capable of storing data or instructions in a form in which they can be retrieved and/or processed by a device. A computer readable medium should not be limited to any particular type or organization, and should be understood to include distributed and decentralized systems however they are physically or logically disposed, as well as storage objects of systems which are located in a defined and/or circumscribed physical and/or logical space. Computer memory such as hard discs, read only memory, random access memory, solid state memory elements, optical discs and registers is an example of a “computer readable medium.”

When used in the claims, “configured” should be understood to mean that the thing “configured” is adapted, designed or modified for a specific purpose. An example of “configuring” in the context of computers is to provide a computer with specific data (which may include instructions) which can be used in performing the specific acts the computer is being “configured” to do. For example, installing Microsoft WORD on a computer “configures” that computer to function as a word processor, which it does by using the instructions for Microsoft WORD in combination with other inputs, such as an operating system, and various peripherals (e.g., a keyboard, monitor, etc).

When used in the claims, the term “data object” should be understood to refer to an identifiable and distinct entity expressed in a form (e.g., data stored in a computer readable medium) which can be manipulated by a computer.

When used in the claims, “database” should be understood be to a collection of data stored on a computer readable medium in a manner such that the data can be retrieved by a computer. The term “database” can also be used to refer to the computer readable medium itself (e.g., a physical object which stores the data).

When used in the claims, the verb “display” refers to the act of providing the thing “displayed” in a visually perceptible form. It should be understood that, in the context of this disclosure, “displaying” refers not only to actually physically presenting a thing on a screen, but also to causing that thing to be presented (e.g., by sending instructions from a local CPU, or by sending information over a network which causes a thing to be “displayed”).

When used in the claims, an “element” of a “set” (defined infra) should be understood to refer to one of the things in the “set.”

When used in the claims, the term “reciprocal date” should be understood to refer to a date for which scheduling an event will compensate for or balance another event between two entities.

When used in the claims, “remote” should be understood to refer to the relationship between entities which are physically distant from one another, such as between entities that communicate over a network.

When used in the claims, the term “set” should be understood to refer to a number, group, or combination of zero or more things of similar nature, design, or function.

When used in the claims, the term “storing” used in the context of a memory or computer readable medium should be understood to mean that the thing “stored” is reflected in one or more physical properties (e.g., magnetic moment, electric potential, optical reflectivity, etc) of the thing doing the “storing” for a period of time, however brief.

When used in the claims, the term “travel sport team” should be understood to refer to a team in a sport in which there are different fields and in which teams play at least a portion of their games by traveling to different fields. Examples of travel sport teams include baseball teams, soccer teams, hockey teams, football teams, lacrosse teams, as well as other teams for which there are home and away games, or for which a team travels to competitions.

Accordingly,

We claim:

1. A system comprising:
a) a database storing a set of data identifying a plurality of organizations, each organization comprising a plurality of travel sport teams;
b) a server configured to:
i) based on input from a first user associated with a first organization, generate an invitation indicating information comprising:
A) a plurality of travel sport teams from the first organization;
B) a proposed date for scheduling games between the plurality of travel sport teams from the first organization and a plurality of travel sport teams from a second organization; and
C) a location for scheduling games between the plurality of travel sport teams from the first organization and the plurality of travel sport teams from the second organization on the proposed date;
ii) provide an interface operable by a second user associated with the second organization to accept the invitation; and
iii) based on receiving a signal indicating acceptance of the invitation, automatically scheduling a plurality of games on the proposed date at the location indicated in the invitation between travel sport teams from the first organization and the second organization.

2. The system of claim 1, wherein the server is further configured to:
a) present a date selection interface to the first user, wherein the date selection interface is operable to allow the first user to select dates for scheduling games for travel sport teams from the first organization; and
b) based on a determination that a date selected by the first user via the date selection interface is a travel date for the first organization, allow the first user to identify which travel sport teams from the first organization should travel on the selected date.

3. The system of claim 2, wherein:
a) the database stores, for each organization from the plurality of organizations, data indicating a set of links between travel sport teams from that organization; and
b) the server is configured to allow the first user to identify which travel sport teams from the first organization should travel on the selected date via a graphical tool which identifies the links for travel sport teams from the first organization indicated by the data stored in the database.

4. The system of claim 1, wherein the server is further configured to:
a) present a date selection interface to the first user, wherein the date selection interface is operable to allow the user to select dates for scheduling games for travel sport teams from the first organization; and
b) based on a determination that a date selected by the first user via the date selection interface is a home date for the first organization, present an interface to indicating links between travel sport teams from a potential opposing organization, wherein, for the potential opposing organization, the date selected by the first user via the date selection interface is a travel date.

5. The system of claim 1, wherein the server is further configured to:
a) present a date selection interface to the first user, wherein the date selection interface is operable to allow the user to select dates for scheduling games for travel sport teams from the first organization; and
b) based on selection of a date by the first user via the date selection interface, automatically identify a set of potential opposing organizations for the selected date by identifying organizations from the plurality of organizations which:
i) comprise one or more travel sport teams which share a league with a travel sport team from the first organization; and
ii) have the selected date as a travel date if the selected date is a home date for the first organization, or have the selected date as a home date if the selected date is a travel date for the first organization;
c) present a list identifying the set of potential opposing organizations to the first user.

6. The system of claim 5, wherein the list identifying the set of potential opposing organizations is ordered based on, for each potential opposing organization:
a) a number of slots for that organization which match slots for the first organization on the selected date; and
b) a number of available teams for that organization on the selected date.

7. A method comprising:
a) based on input from a first user computer operated by a first user associated with a first organization, generating, through execution of computer executable instructions by a server, an invitation indicating information comprising:
i) a plurality of travel sport teams from the first organization;
ii) a proposed date for scheduling games between the plurality of travel sport teams from the first organization and a plurality of travel sport teams from a second organization; and
iii) a location for scheduling games between the plurality of travel sport teams from the first organization and the plurality of travel sport teams from the second organization on the proposed date;
b) displaying, on a second user computer located remotely from the server and the first user computer, an interface operable by a second user associated with the second organization to accept the invitation; and
c) based on receiving a signal indicating acceptance of the invitation, automatically scheduling a plurality of games on the proposed date at the location indicated in the invitation between travel sport teams from the first organization and the second organization.

8. The method of claim 7, further comprising:
a) presenting a date selection interface to the first user, wherein the date selection interface is operable to allow the first user to select dates for scheduling games for travel sport teams from the first organization; and
b) based on a determination that a date selected by the first user via the date selection interface is a travel date for the first organization, allowing the first user to identify which travel sport teams from the first organization should travel on the selected date.

9. The method of claim 8, comprising presenting, via a graphical tool displayed on the first user computer, information identifying links for travel sport teams from the first organization.

10. The method of claim 7, further comprising:
a) presenting a date selection interface to the first user, wherein the date selection interface is operable to allow the first user to select dates for scheduling games for travel sport teams from the first organization; and
b) based on a determination that a date selected by the first user via the date selection interface is a home date for the first organization, presenting an interface to indicating links between travel sport teams from a potential opposing organization, wherein, for the potential opposing organization, the date selected by the first user via the date selection interface is a travel date.

11. The method of claim 7, further comprising:
a) presenting a date selection interface via the first user computer, wherein the date selection interface is operable to allow the first user to select dates for scheduling games for travel sport teams from the first organization; and
b) based on selection of a date by the first user via the date selection interface, automatically identifying a set of potential opposing organizations for the selected date by identifying organizations which:
i) comprise one or more travel sport teams which share a league with a travel sport team from the first organization; and
ii) have the selected date as a travel date if the selected date is a home date for the first organization, or have the selected date as a home date if the selected date is a travel date for the first organization;
c) presenting a list identifying the set of potential opposing organizations to the first user.

12. The method of claim 11, wherein the list identifying the set of potential opposing organizations is ordered based on, for each potential opposing organization:
a) a number of slots for that organization which match slots for the first organization on the selected date; and
b) a number of available teams for that organization on the selected date.

13. A non-transitory computer readable medium having stored thereon a set of data operable to configure a computer to:
a) based on input from a first user associated with a first organization, generate an invitation indicating information comprising:
i) a plurality of travel sport teams from the first organization;
ii) a proposed date for scheduling games between the plurality of travel sport teams from the first organization and a plurality of travel sport teams from a second organization; and
iii) a location for scheduling games between the plurality of travel sport teams from the first organization and the plurality of travel sport teams from the second organization on the proposed date;
b) displaying an interface operable by a second user associated with the second organization to accept the invitation; and
c) based on receiving a signal indicating acceptance of the invitation, automatically scheduling a plurality of games on the proposed date at the location indicated in the invitation between travel sport teams from the first organization and the second organization.

14. The non-transitory computer readable medium of claim 13, wherein the set of data stored on the medium is further operable to configure the computer to:
a) present a date selection interface to the first user, wherein the date selection interface is operable to allow the first user to select dates for scheduling games for travel sport teams from the first organization; and
b) based on a determination that a date selected by the first user via the date selection interface is a travel date for the first organization, allow the first user to identify which travel sport teams from the first organization should travel on the selected date.

15. The non-transitory computer readable medium of claim 14, wherein the set of data stored on the medium is further operable to configure the computer to present information identifying links for travel sport teams from the first organization.

16. The non-transitory computer readable medium of claim 13, wherein the set of data stored on the medium is further operable to configure the computer to:
a) present a date selection interface to the first user, wherein the date selection interface is operable to allow the first user to select dates for scheduling games for travel sport teams from the first organization; and
b) based on a determination that a date selected by the first user via the date selection interface is a home date for the first organization, present an interface to indicating links between travel sport teams from a potential opposing organization, wherein, for the potential opposing organization, the date selected by the first user via the date selection interface is a travel date.

17. The non-transitory computer readable medium of claim 16, wherein the set of data stored on the medium is further operable to configure the computer to:
a) present a date selection interface, wherein the date selection interface is operable to allow the first user to select dates for scheduling games for travel sport teams from the first organization; and
b) based on selection of a date by the first user via the date selection interface, automatically identify a set of potential opposing organizations for the selected date by identifying organizations which:
i) comprise one or more travel sport teams which share a league with a travel sport team from the first organization; and
ii) have the selected date as a travel date if the selected date is a home date for the first organization, or have the selected date as a home date if the selected date is a travel date for the first organization;
c) presenting a list identifying the set of potential opposing organizations to the first user.

18. The non-transitory computer readable medium of claim 17, wherein the list identifying the set of potential opposing organizations is ordered based on, for each potential opposing organization:
a) a number of slots for that organization which match slots for the first organization on the selected date; and
b) a number of available teams for that organization on the selected date.
